(19) United States
(12) Patent Application Publication
(10) Pub. No.: US 2008/0281897 A1
(43) Pub. Date: Nov. 13, 2008

(54) Universal execution unit

(76) Inventor: Daaven S. Messinger, Austin, TX (US)

Correspondence Address: Daaven S. Messinger, 2805 Norfolk Drive, Austin, TX, 78745, US

(21) Appl. No.: 12/151,506

(22) Filed: May 7, 2008

Related U.S. Application Data
(60) Provisional application No. 60/928,006, filed on May 7, 2007.

(51) Int. Cl. G06F 7/50; G06F 9/302; G06F 9/305

(52) U.S. Cl. 708/708; 712/220; 712/E09.017; 712/E09.018

(57) ABSTRACT

Methods and apparatus are described for an execution unit. A method includes receiving an instruction and one or more operands, determining a plurality of program bits and one or more sets of pluralities of select input bits, based on the instruction and the one or more operands, determining a plurality of extra adder input bits, based on the instruction and the one or more operands, determining a plurality of multiplexer output bits, based on the plurality of program bits and the one or more sets of pluralities of select input bits, determining one or more carry-save adder tree outputs, based on the plurality of multiplexer output bits and the plurality of extra adder input bits, determining a carry-propagate adder sum output, based on the one or more carry-save adder tree output; and determining the result of the instruction on the one or more operands, based on the carry-propagate adder sum output. An apparatus includes a finite state machine comprising an instruction input, a plurality of operand inputs, a plurality of outputs, a plurality of extra adder inputs, a result output, and condition code output flags, an array of multiplexers coupled to the plurality of outputs and comprising a plurality of multiplexer outputs, a carry-save adder tree coupled to the plurality of multiplexer outputs and coupled to the extra adder inputs and comprising a plurality of carry-save adder tree outputs coupled to the finite state machine, and a carry-propagate adder coupled to the plurality of carry-save adder tree outputs and comprising a plurality of carry-propagate adder outputs coupled to the finite state machine.

### CROSS-REFERENCE TO RELATED APPLICATIONS

This application claims the benefit of U.S. Provisional Application Ser. No. 60/928,006 entitled “UNIVERSAL EXECUTION UNIT,” filed on May 7, 2007, which is incorporated herein by reference.

### BACKGROUND INFORMATION

1. Field of the Invention

Embodiments of the invention relate generally to the field of electrical computer systems and digital data processing systems. More particularly, an embodiment of the invention relates to an execution unit (EU) and methods of executing data processing instructions.

2. Discussion of the Related Art

The trend in computer processors is to accommodate applications that demand greater performance and speed yet use less power and are implemented in less silicon area.

Execution units are the basic computation engines within typical processors. An EU accepts a stream of operands and operations to be performed and generates the required results. The computational power of the processor is dependent on the instructions that can be performed by the EU.

FIG. 1 depicts a standard processor unit including an EU 150. An instruction decoder 110 receives instructions from program memory 120 based on a program counter 130. The instruction decoder controls the blocks on the right (program memory 120, program counter 130, register file 140, execution unit 150, and data memory 160) to perform the required operation. The register file 140 holds short-term data that is to be processed by the EU 150. The data memory 160 holds more long-term data being manipulated by the processor. The execution unit 150 takes as its input two operands (AOP and BOP) from the register file 140 and the decoded instruction from the instruction decoder 110. The execution unit 150 then generates the required output result that is sent to the program counter 130, the register file 140, or the data memory 160.

FIG. 2 depicts a typical execution unit. Independent function blocks 201-215 accept input operands and generate results 221-235, which are sent to the multiplexer (MUX) 240. The multiplexer selects the correct output according to the instruction (INS). Logic synthesis 260 is commonly used to improve circuit size, timing and power consumption by optimizing the individual blocks and/or the entire EU to arrive at a logic-optimized circuit 270. EU design is a balancing act. Complex operations increase processor performance but not without adverse effects on circuit size, timing and power consumption.

One problem with this existing approach is that power consumption is high and circuit size is large because all the blocks exist and are operational even though only one function block output is selected. Therefore, what is required is a solution that reduces power consumption and circuit size.

Heretofore, the requirements of more complex instructions, low power consumption, smaller circuit size, and lower design cost referred to above have not been fully met. What is needed is a solution that solves all of these problems.

### SUMMARY OF THE INVENTION

There is a need for the following embodiments of the invention. Of course, the invention is not limited to these embodiments.

According to an embodiment of the invention, a process includes receiving an instruction and one or more operands, determining a plurality of program bits and one or more sets of pluralities of select input bits (based on the instruction and the one or more operands), determining a plurality of extra adder input bits (based on the instruction and the one or more operands), determining a plurality of multiplexer output bits (based on the plurality of program bits and the one or more sets of pluralities of select input bits), determining one or more carry-save adder tree outputs (based on the plurality of multiplexer output bits and the plurality of extra adder input bits), determining a carry-propagate adder sum output (based on the one or more carry-save adder tree outputs), and determining the result of the instruction on the one or more operands (based on the carry-propagate adder sum output).

According to another embodiment of the invention, a machine includes a finite state machine comprising an instruction input, a plurality of operand inputs, a plurality of outputs, a plurality of extra adder inputs, a result output and condition code output flags; an array of multiplexers coupled to the plurality of outputs and comprising a plurality of multiplexer outputs; a carry-save adder tree coupled to the plurality of multiplexer outputs and coupled to the extra adder inputs and comprising a plurality of carry-save adder tree outputs coupled to the finite state machine; and a carry-propagate adder coupled to the plurality of carry-save adder tree outputs and comprising a plurality of carry-propagate adder outputs coupled to the finite state machine.

According to another embodiment of the invention, a machine includes an execution unit configured to execute a plurality of instructions through substantially the same data path.

These and other embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of an embodiment of the invention without departing from the spirit thereof, and embodiments of the invention include all such substitutions, modifications, additions and/or rearrangements.

### BRIEF DESCRIPTION OF THE DRAWINGS

The drawings accompanying and forming part of this specification are included to depict certain embodiments of the invention. A clearer conception of embodiments of the invention, and of the components combinable with, and operation of systems provided with, embodiments of the invention, will become more readily apparent by referring to the exemplary, and therefore nonlimiting, embodiments illustrated in the drawings, wherein identical reference numerals (if they occur in more than one view) designate the same elements. Embodiments of the invention may be better understood by reference to one or more of these drawings in combination with the description presented herein. It should be noted that the features illustrated in the drawings are not necessarily drawn to scale.

FIG. 1 illustrates an existing execution unit, labeled “PRIOR ART”.

FIG. 2 illustrates an existing execution unit in greater detail, labeled “PRIOR ART”.

FIG. 3 illustrates an embodiment of the present invention.

FIG. 4 illustrates operand types for SIMD operation.

FIG. 5 illustrates MUX 320 logic circuit.

FIG. 6A lists VHDL code showing interconnects between FSM 310 and the MUX 320 blocks (8 bit example).

FIG. 6B illustrates the interconnection between FSM 310 and the MUX 320 blocks (8-bit example).

FIG. 7 illustrates possible partitioning of WAL 330 and ADD 340 circuits to support SIMD operations.

FIG. 8 illustrates a SIMD implementation of ADD 340 using a modified Brent-Kung adder circuit.

FIG. 9A illustrates possible segmentation of WAL 330 circuits to allow wide EU results.

FIG. 9B illustrates possible segmentation of WAL 330 modes to allow wide EU results.

FIG. 10A lists the basic structure of FSM 310 comprising default section and instruction decoding.

FIG. 10B lists the basic structure of FSM 310 comprising output section and actual versus expected value assertion (continued from FIG. 10A).

FIG. 11 lists an implementation of FSM 310 to support logical operations.

FIG. 12 lists an implementation of FSM 310 to support addition and subtraction.

FIG. 13A lists an implementation of FSM 310 to support byte vector absolute value operations.

FIG. 13B lists an implementation of FSM 310 to support half vector absolute value operations.

FIG. 13C lists an implementation of FSM 310 to support word scalar absolute value operations.

FIG. 14 lists an implementation of FSM 310 to support bit-counting operations.

FIG. 15 lists an implementation of FSM 310 to support vector summation.

FIG. 16 lists an implementation of FSM 310 to support bit reversal.

FIG. 17A lists an implementation of FSM 310 to support rotate and shift operations.

FIG. 17B lists an implementation of FSM 310 to support rotate and shift operations (continued from FIG. 17A).

FIG. 18 illustrates the standard Booth algorithm, labeled “PRIOR ART”.

FIG. 19 illustrates an implementation of FSM 310 to support signed half vector multiplication.

FIG. 20 illustrates an implementation of FSM 310 to support signed byte vector multiplication.

FIG. 21 illustrates an implementation of FSM 310 to support byte vector complex multiply accumulate.

FIG. 22 illustrates an implementation of a scalar mask generator.

FIGS. 23A, 23B lists an implementation of a vector mask generator.

FIG. 24 lists an implementation of FSM 310 to support bit field clear and set operations.

FIGS. 25A, 25B, 25C lists a double precision floating-point multiply implementation.

FIG. 26 illustrates an alternative implementation by flattening FSM 310 and MUX 320 through the use of logic synthesis.

FIG. 27 illustrates an alternative implementation by flattening instruction decode ID 110 and FSM 310 through the use of logic synthesis.

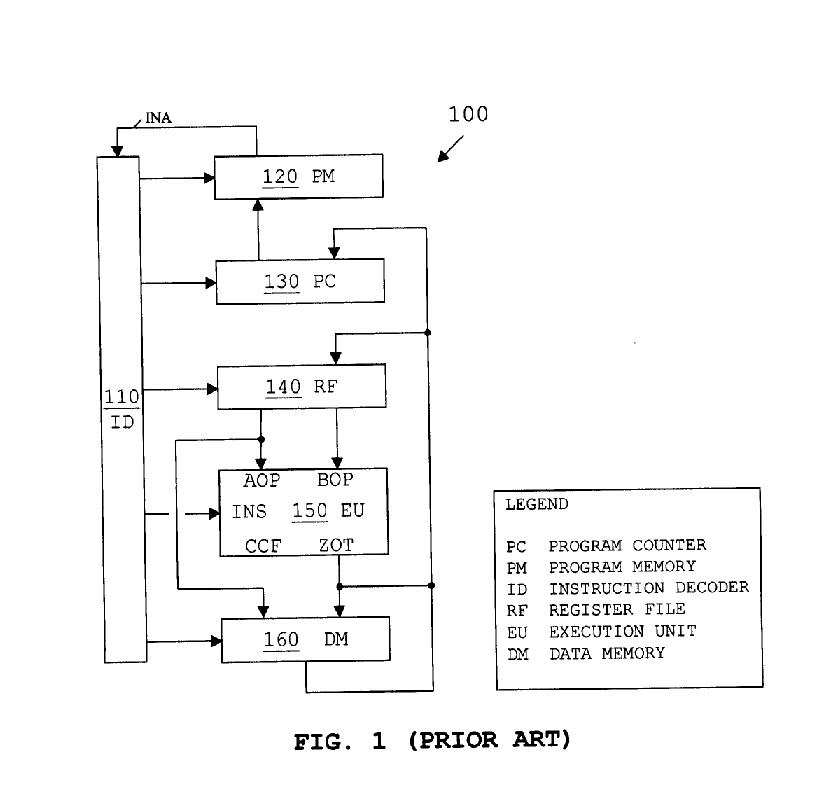

### DESCRIPTION OF PREFERRED EMBODIMENTS

Embodiments of the invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the embodiments of the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

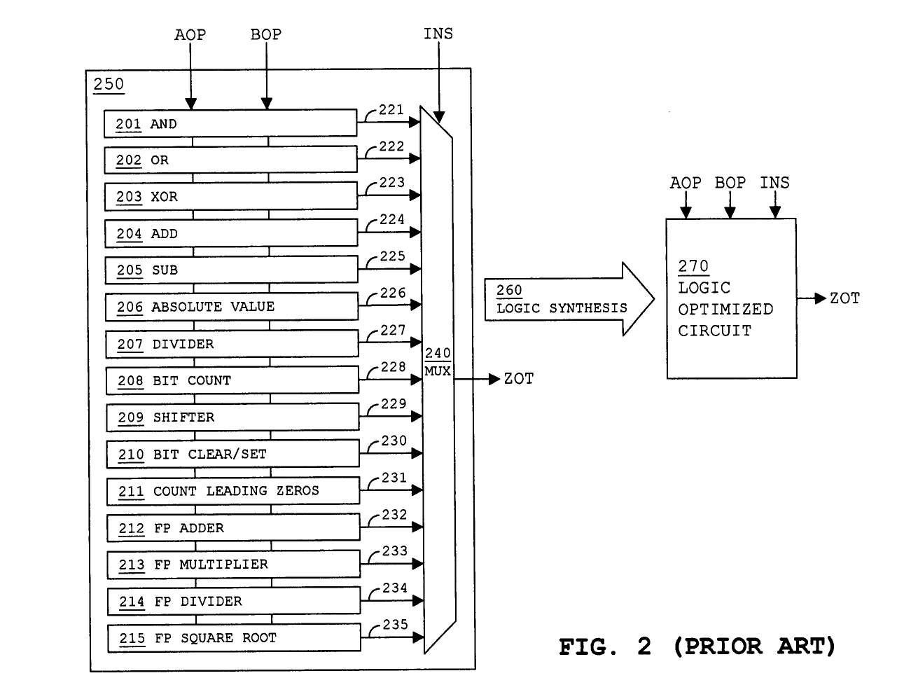

In general, the context of an embodiment of the invention may include an execution unit that reduces power consumption compared to existing execution units by not activating all the independent function blocks during each clock cycle (see FIG. 2).

The EU may be utilized within a microprocessor, micro controller, digital signal processor, or equivalent integrated circuit. The EU may form part of an integrated circuit on a circuit board implemented in any electronic device. Such devices may include, but are not limited to a mobile communication device such as a cell phone, a PDA, a media playing device such as an MP3 player, a digital video disc (DVD) player, a video game playing device, a laptop computer, a desktop device (i.e., a personal computer or a workstation), a household appliance (e.g., a microwave oven and/or appliance remote control), an automobile radio faceplate, a television, a point-of-sale terminal, an automated teller machine, an industrial device (e.g., test equipment, control equipment), or any other device that requires manipulation of digital data.

In the figures and examples that follow, a 32-bit execution unit is described for illustration purposes unless otherwise indicated. It is to be understood that a different number of bits may be used.

### Operation of the Execution Unit

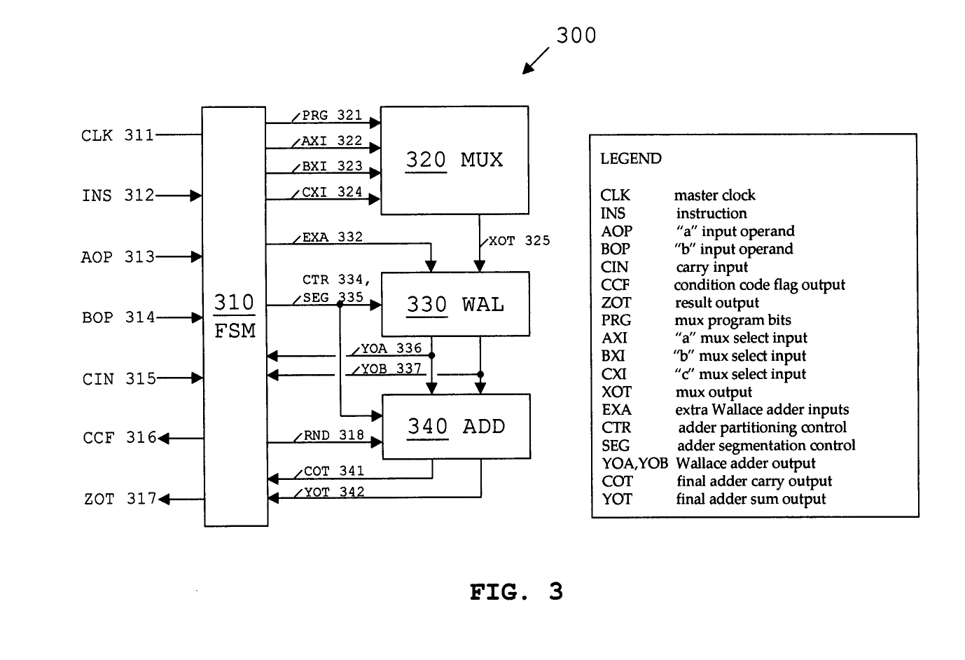

FIG. 3 depicts an embodiment of the invention. An execution unit (EU) uses a single circuit 300 to implement a plurality of operations. An exemplary set of instructions is given in Table 1. It should be appreciated that the set of instructions that can be carried out by execution unit 300 can be increased or decreased as needed. A method of increasing or decreasing the set of instructions that can be executed by EU 300 will be described below.

The components of EU 300 could be implemented in a variety of ways including programmable logic array (PLA), field programmable gate array (FPGA), memory-based finite-state machine, gate-array, application-specific integrated circuit (ASIC), structured ASIC, standard cell ASIC, or application-specific standard product (ASSP) circuits.

TABLE 1

| OPCODE | OPERATION |
|---|---|
| NOP | no operation |
| ABS_1 | absolute value (byte vector) |
| ABS_2 | absolute value (half vector) |
| ABS_4 | absolute value (word scalar) |
| ADC_1 | add with carry (byte vector) |
| ADC_2 | add with carry (half vector) |
| ADC_4 | add with carry (word scalar) |
| ADD_1 | add (byte vector) |
| ADD_2 | add (half vector) |
| ADD_4 | add (word scalar) |
| AND | logical and |
| ANDI | logical invert then and |
| BITR_1 | bit reverse (byte vector) |
| BITR_2 | bit reverse (half vector) |
| BITR_4 | bit reverse (word scalar) |
| CLR_1 | clear bits (byte vector) |
| CLR_2 | clear bits (half vector) |
| CLR_4 | clear bits (word scalar) |
| CMA_1 | complex multiply accumulate (byte vector) |
| CMA_2 | complex multiply accumulate (half vector) |
| CNT0_1 | count zero bits (byte vector) |
| CNT0_2 | count zero bits (half vector) |
| CNT0_4 | count zero bits (word scalar) |
| CNT1_1 | count one bits (byte vector) |
| CNT1_2 | count one bits (half vector) |
| CNT1_4 | count one bits (word scalar) |
| FMUL_8 | floating point multiply (64-bit) |
| MULS_1 | multiply signed (byte vector) |
| MULS_2 | multiply signed (half vector) |
| MULS_4 | multiply signed (word scalar) |
| MULU_1 | multiply unsigned (byte vector) |
| MULU_2 | multiply unsigned (half vector) |
| MULU_4 | multiply unsigned (word scalar) |
| NOT | logical not |
| OR | logical or |
| ORI | logical invert then or |
| ROL_1 | rotate left (byte vector) |
| ROL_2 | rotate left (half vector) |
| ROL_4 | rotate left (word scalar) |
| ROR_1 | rotate right (byte vector) |
| ROR_2 | rotate right (half vector) |
| ROR_4 | rotate right (word scalar) |
| SBC_1 | subtract with carry (byte vector) |
| SBC_2 | subtract with carry (half vector) |
| SBC_4 | subtract with carry (word scalar) |
| SET_1 | set bits (byte vector) |
| SET_2 | set bits (half vector) |
| SET_4 | set bits (word scalar) |
| SHLS_1 | shift left signed (byte vector) |
| SHLS_2 | shift left signed (half vector) |
| SHLS_4 | shift left signed (word scalar) |
| SHLU_1 | shift left unsigned (byte vector) |
| SHLU_2 | shift left unsigned (half vector) |
| SHLU_4 | shift left unsigned (word scalar) |
| SHRS_1 | shift right signed (byte vector) |
| SHRS_2 | shift right signed (half vector) |
| SHRS_4 | shift right signed (word scalar) |
| SHRU_1 | shift right unsigned (byte vector) |
| SHRU_2 | shift right unsigned (half vector) |
| SHRU_4 | shift right unsigned (word scalar) |
| SUB_1 | subtract (byte vector) |
| SUB_2 | subtract (half vector) |
| SUB_4 | subtract (word scalar) |
| SUMS_1 | sum byte vector signed |
| SUMS_2 | sum half vector signed |
| SUMU_1 | sum byte vector unsigned |
| SUMU_2 | sum half vector unsigned |
| XNOR | logical xnor |
| XOR | logical xor |

### Execution Unit Structure

EU 300 of FIG. 3 may include the following components. The data path is represented by MUX 320, WAL 330 and ADD 340 components that are shared by all instructions. The finite-state machine FSM 310 controls the data path. The MUX 320 block contains an array of multiplexers that generate XOT bus line 325. The WAL 330 is a Wallace carry-save adder tree and ADD 340 is a carry-propagate adder. The WAL 330 and the ADD 340 blocks sum the XOT 325 and EXA 332 buses. It should be appreciated that any adder circuit that can sum the XOT and EXA buses may be substituted for WAL 330 and ADD 340 blocks.

Finite state machine FSM 310 component may be coupled to receive a plurality of inputs. A dock input line 311 sets the dock cycle and synchronizes the operation of the EU. An instruction input line 312 receives the instruction to be performed on a plurality of operands. For example, and not by way of limitation, two operand input lines, an A operand input line 313, and a B operand input line 314, are depicted in FIG. 3. However, it is to be understood that the number of operands may vary. Carry input line 315 may be present to provide a carry input value for an instruction. Condition code flag output line 316 may be present to indicate that the result is zero, is negative, has overflowed or has generated carry-out, etc. Output line ZOT 317 provides the output result of the instruction performed on the operands.

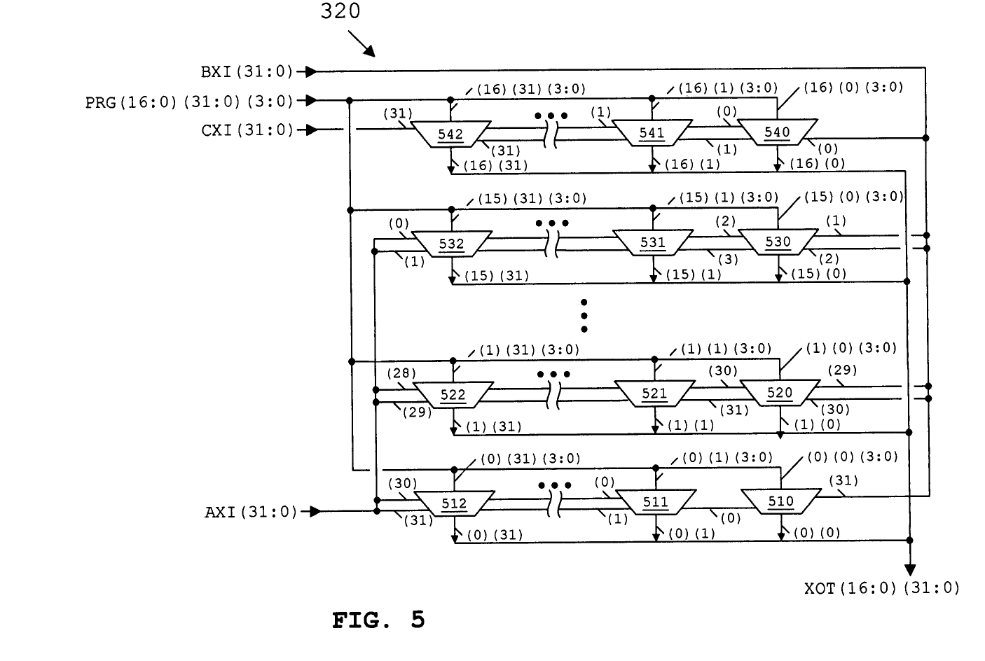

EU 300 may be coupled to multiplexer array MUX 320 through a plurality of outputs. For example, and not by way of limitation, four output lines are depicted in FIG. 3. PRG 321 provides the program bits that may be determined by the instruction and operands received by the FSM. In addition, AXI 322, BXI 323, and CXI 324 select input lines may be coupled to the select lines of the multiplexers in array MUX 320. The operation of MUX 320 will be explained in detail below with reference to FIGS. 5-7. MUX 320 may be coupled to WAL 330 by single output line XOT 325.

WAL 330 is a carry-save adder tree that can add m operands in a time that is proportional to log 2(m). WAL 330 may be coupled to extra adder input line EXA 332 from FSM 310. WAL 330 may also be coupled to an adder partitioning control line CTR 334 and adder segmentation control line SEG 335 from FSM 310. The purpose of extra adder input line EXA 332 and adder partitioning control line CTR 334 and adder segmentation control line SEG 335 will be explained in detail below. The outputs of WAL 330 may include two outputs, YOA 336 and YOB 337, which may be coupled as input to both ADD 340 and FSM 310. Outputs YOA 336 and YOB 337 may, among other things, make a partial result of the instruction being executed by EU 300 available to FSM 310.

Carry propagate adder ADD 340 may receive two input lines YOA 336 and YOB 337 from WAL 330 and perform an addition on these inputs. ADD 340 may also be coupled to adder partitioning control line CTR 334 and adder segmentation control line SEG 335 as an input from FSM 310. ADD 340 may also be coupled to FSM 310 through RND line 318, which acts as a fast carry-in for floating-point rounding. The output of ADD 340 may be coupled to FSM 310 through result line YOT 342 and carry output line COT 341. FSM 310 may, in turn, take these lines COT 341 and YOT 342 and generate the condition code flags CCF 316 and the final EU results output ZOT 317.

One advantage of the aforementioned design is that all instructions implemented by the execution unit share the same data path. This is in contrast to existing designs where instructions are coded in separate logical blocks. In conventional designs, all logical blocks are active and only one output is selected. An execution unit consistent with the invention uses the same data path for all instructions. Furthermore, during the execution of many instructions, most of the XOT 325 and EXA 332 are zeroes. Since adding zeros in the WAL 330 and ADD 340 uses less power, the overall power consumption is reduced.

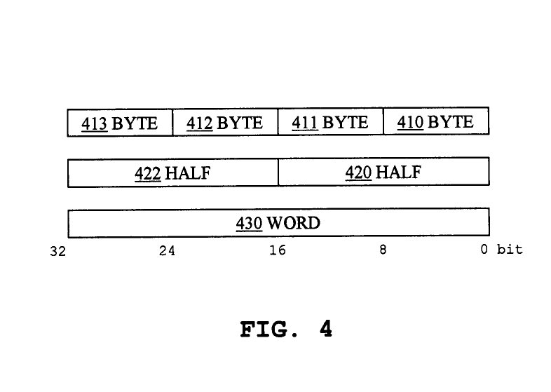

The EU may use a single circuit 300 (FIG. 3) to implement a plurality of operations including Single Instruction Multiple Data (SIMD) instructions. SIMD allows the same operation to be performed on multiple pieces of data in parallel. FIG. 4 depicts an exemplary operand format given for a 32-bit EU. Operands supplied to the EU may be treated as single 32-bit words 430, two 16-bit halves 420 and 422, or 4 8-bit bytes 410, 411, 412 and 413. Thus, when an operand is treated as 4 bytes, 4 pieces of data may be acted on during a single instruction execution.

FIG. 5 depicts an exemplary configuration of MUX 320. FIG. 5 depicts a MUX 320 for a 32-bit EU where the MUX 320 includes an array of multiplexers with 17 rows and 32 columns. Given an n-bit EU, the MUX 320 will generally be an array of (n/2+1)×n multiplexers. The inputs to the array of multiplexers are three operand lines AXI, BXI, and CXI, each of which is a 32-bit bus. The fourth input is the PRG program line, which consists of 17 rows of 32 buses, where each bus is 4 bits long. The 4-bit bus is designated as (3:0) in FIG. 5, the rows are designated as (16:0) and the columns are designated as (31:0). In general, for an n-bit EU, the PRG line will have (n/2+1) rows of n 4-bit buses. The 4 bits of each PRG bus are the inputs of each 4-to-1 multiplexer. The various bits of the AXI, BXI, and CXI lines form the select lines of the 4-to-1 multiplexers. Each multiplexer in the array thus receives as its input one of the PRG 4-bit buses as well as a least significant select bit (lsb) from either the AXI, BXI, or CXI bus and a most significant select bit (msb) from either the AXI, BXI, or CXI bus.

The output of MUX 320 can be written as:
XOT(r,x)<=PRG(r,x,0) when sel(r,x)=“00” else
   PRG(r,x,1) when sel(r,x)=“01” else
   PRG(r,x,2) when sel(r,x)=“10”, else
   PRG(r,x,3);

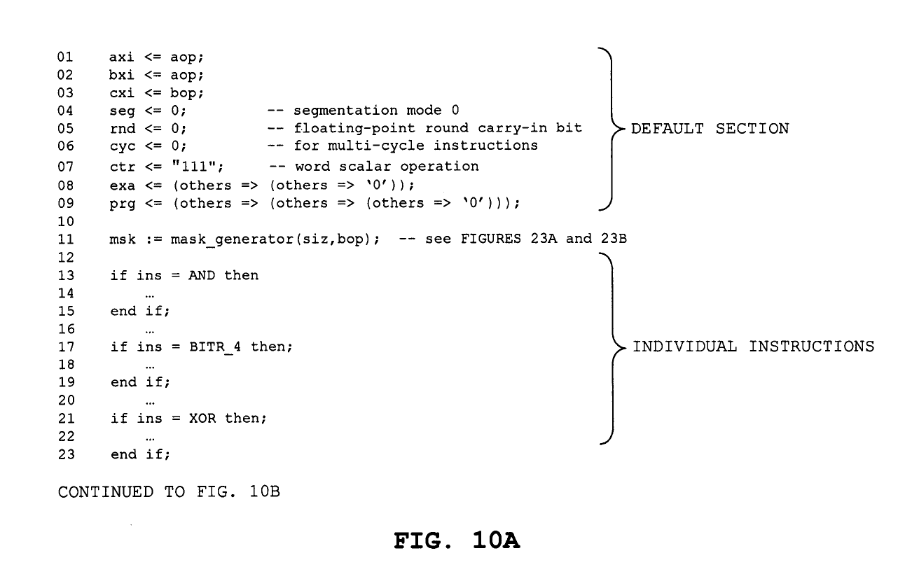

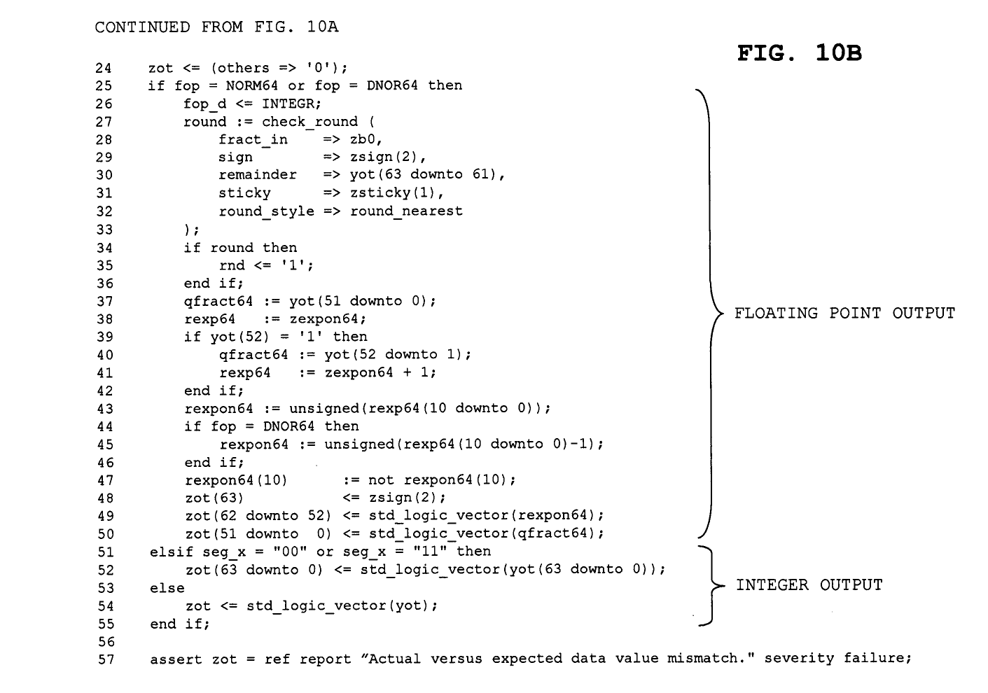

The values set for the AXI, BXI, CXI, and PRG lines are determined by the FSM 310 based on the instruction and the operands. How the FSM 310 determines these values will be explained below with reference to FIGS. 10A and 10B. For example, for many instructions, one of the AXI, BXI, or CXI buses may be assigned the A operand of the instruction, another one of the AXI, BXI, or CXI buses may be assigned the B operand, and one of the rows of buses of the PRG line may be assigned a constant for each of the buses of that row where the constant may depend on the specific instruction. Therefore, the operands may act as select lines on the constant value of the buses of the PRG line. For other instructions, this may not be true. As stated above, this will be explained in greater detail below with reference to FIGS. 10A and 10B.

The top row in FIG. 5 MUX 320 differs from the other rows and will be described first. Each multiplexer in the top row of 32 multiplexers receives as input one bus from row (16) of the buses the PRG line. Thus, counting from right to left, first multiplexer 540 receives the PRG(16) (0) (3:0) bus, second multiplexer 541 receives the PRG(16) (1) (3:0) bus, and so on until the last multiplexer 542 which receives the PRG(16) (31) (3:0) bus. The lsb select line in each multiplexer in the first row of MUX 320 receives a bit from the BXI bus. Again going from right to left, first multiplexer 540 lsb select line receives the BXI(0) bit, second multiplexer 541 receives the BXI(1) bit, and so on until the last multiplexer 542 receives the BXI(31) bit. The msb select line in each multiplexer in the first row of MUX 320 receives a bit from the CXI bus. Going from right to left, first multiplexer 540 msb select line receives the CXI(0) bit, second multiplexer 541 receives the CXI(1) bit, and so on until the last multiplexer 542 receives the CXI(31) bit.

The second row of MUX 320 will now be described. The second row of multiplexers receives as the input row PRG(15) buses. Thus, first multiplexer 530 receives the four bits of the first bus of row (15), or PRG(15) (0) (3:0). Second multiplexer 531 receives the second bus of row PRG(15), or PRG(15) (1) (3:0), and so on, until the last multiplexer 532 receives the PRG(15) (31) (3:0) bus. First multiplexer 530 receives the BXI(1) bit as the msb select line, and the BXI(2) bit as the lsb select line. Second multiplexer 531 receives the BXI(2) bit as the msb select line, and the BXI(3) bit as the lsb select line. This pattern is repeated until the last bit BXI(31) is reached for the msb select line, at which point the multiplexer lsb select line in the row receives the AXI(0) bit. Thus, the next to last multiplexer in the second row that receives the PRG(15) (30) (3:0), has as the msb select line the BXI(31) bit and the AXI(0) bit as the lsb select line. Last multiplexer 532 receives the AXI(0) bit as the msb select line and the AXI(1) bit as the lsb select line.

This pattern is repeated down the rows of multiplexers. Each subsequent row begins with the next higher bit of the BXI bus, and switches to the AXI bus when the last bit of the BXI bus is reached. For example, the second to last row of multiplexers is connected as follows. Each multiplexer in the second to last row receives the PRG(1) bus. Going from right to left, first multiplexer 520 receives the PRG(1) (0) (3:0) bus, second multiplexer 521 receives the PRG(1) (1) (3:0) bus, and so on until last multiplexer 522 receives the PRG(1) (31) (3:0) bus. First multiplexer 520 in the second to last row receives the BXI(29) bit as the msb select line input and the BXI(30) bit as the lsb select line input. Second multiplexer 521 in the second to last row receives the BXI(30) bit as the msb select line input and the BXI(31) bit as the lsb select line input. The next multiplexer would thus receive the BXI(31) bit as the msb select line input and the AXI(0) bit as the lsb select line input. Last multiplexer 522 in this row thus receives the AXI(28) bit as the msb select line input and the AXI(29) bit as the lsb select line input.

For completion, the last row of MUX 320 will be described. The last row in MUX 320 receives the PRG(0) buses as the input lines to each multiplexer. Thus, first multiplexer 510 receives the PRG(0) (0) (3:0) bus, second multiplexer 511 receives the PRG(0) (1) (3:0) bus, and so on until last multiplexer 512, which receives the PRG(0) (31) (3:0) bus. First multiplexer 510 receives the BXI(31) bit as the msb select line input and the AXI(0) bit as the lsb select line input, second multiplexer 511 receives the AXI(0) bit as the msb select line input and the AXI(1) bit as the lsb select line input, and last multiplexer 512 receives the AXI(30) bit as the msb select line input and the AXI(31) bit as the lsb select line input.

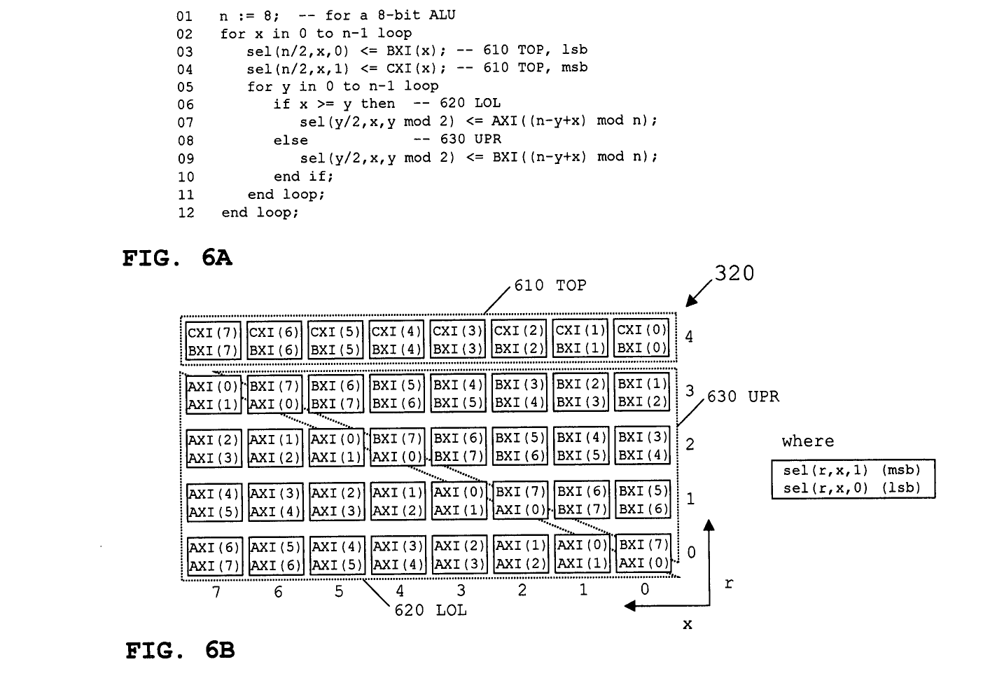

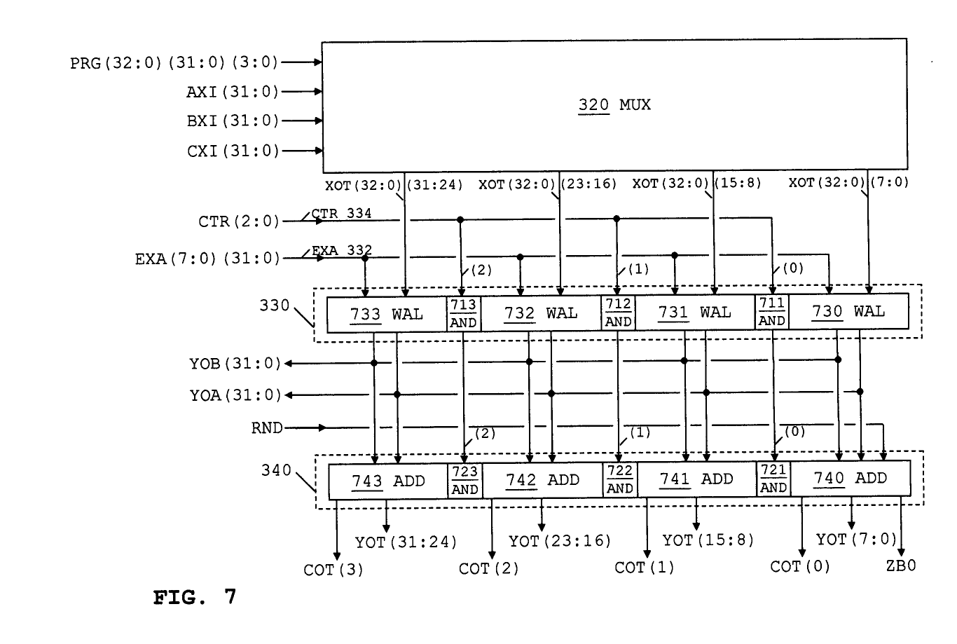

As can be seen in FIG. 5, with each subsequent row of multiplexers, the bits of the BXI line shift to the right until the last bit is reached, at which point the bits of the AXI line begin. This connection pattern allows for efficient EU implementation. This arrangement can be better seen in FIG. 6B, which is described below.

FIG. 6A lists VHSIC Hardware Description Language (VHDL) code used to connect the AXI, BXI and CXI buses to the multiplexers in separate regions TOP 610, LOL 620 and UPR 630 (8-bit EU example). In FIG. 6A line 01, n represents the number of bits and is set to 8 in this example.

FIG. 6B shows the assignment of the select lines for each multiplexer in such an array for an 8-bit implementation. As shown, for an implementation of n bits, the MUX 320 has n/2+1 rows numbered from 0 to n/2, and n columns, numbered from 0 to n−1. In the 8-bit case shown in FIG. 6B, the array has 5 rows, numbered from 0 to 4, and 8 columns, numbered from 0 to 7. In top row 610, the select lines are assigned as follows. For the top row, the lsb select line is assigned the corresponding bit from the BXI bus, and the msb select line is assigned the corresponding bit from the CXI bus. Thus, FIG. 6A, line 03, sel(4,x,0)=BXI(x) for all 0≦x<n, and line 04, sel(4,x,1)=CXI(x) for all 0≦x≦n. The select lines of the rest of the multiplexers in MUX 320 in FIG. 6B are assigned bits from the AXI and BXI buses. In the first (bottom) row, the first multiplexer is assigned the AXI(0) bit to lsb select line and the BXI(7) bit to msb select line. The second multiplexer in the first row is assigned the next bit in each bus, namely the AXI(1) bit for lsb select line and the AXI(0) bit for msb select line. The next row in the array is shifted to the left by two bit positions. This results in lower left triangle 620 of MUX 320 in FIG. 6B with assigned bits from the AXI bus, and upper right triangle 630 of MUX 320 in FIG. 6B with assigned bits from the BXI bus. The VHDL code for achieving this arrangement is shown in FIG. 6A, where x is the column number and y/2 is the row number. For lower left triangle 620 in FIG. 6B, x>=y and thus the select lines are assigned bits from the AXI bus (see FIG. 6A line 07), and for upper right triangle 630, x<y and the select lines of the multiplexers are assigned bits from the BXI bus (see FIG. 6A line 09). While FIGS. 6A and 6B depicted an 8-bit example, any number of bits can be implemented.

### Data Path Partitions

FIG. 7 illustrates an exemplary arrangement of WAL 330 and ADD 340 in connection with MUX 320 for a 32-bit EU. As shown in FIG. 7, WAL 330 and ADD 340 may be partitioned to implement SIMD instructions. MUX 320 output bus XOT and EXA 332 bus may be partitioned into 4 buses. Correspondingly, WAL 330 and ADD 340 may be partitioned into 4 byte sections. The 8 least significant bits of XOT and EXA buses connect to WAL 730, the next eight bits of XOT and EXA buses connect to WAL 731, the next eight bits of XOT and EXA buses connect to WAL 732, and the last eight bits of XOT and EXA buses connect to WAL 733. CTR line 334 provides for adder partition control. The value of the CTR bits is ANDed with the carries at the section boundaries. Therefore, at node 711, when the CTR bit 0 is set to “0”, the carries from WAL 730 are not propagated to the WAL 731. This is similar with the other byte sections. Thus, setting each CTR bit to “0” has the effect of partitioning the adder into, in this example, four sections, allowing for the separate addition of four pieces of data. The SIMD modes for byte, half and word operation are achieved by setting the CTR bus shown in Table 2.

TABLE 2

| CTR(2:0) | OPERATION |
|---|---|
| 000 | ZOT(7:0) <= XOT(16:0)(7:0) + EXA(7:0)(7:0); |
| | ZOT(15:8) <= XOT(16:0)(15:8) + EXA(7:0)(15:8); |
| | ZOT(23:16) <= XOT(16:0)(23:16) + EXA(7:0)(23:16); |
| | ZOT(31:24) <= XOT(16:0)(31:24) + EXA(7:0)(31:24); |
| 101 | ZOT(15:0) <= XOT(16:0)(15:0) + EXA(7:0)(15:0); |
| | ZOT(31:16) <= XOT(16:0)(31:16) + EXA(7:0)(31:16); |
| 111 | ZOT(31:0) <= XOT(16:0)(31:0) + EXA(7:0)(31:0); |

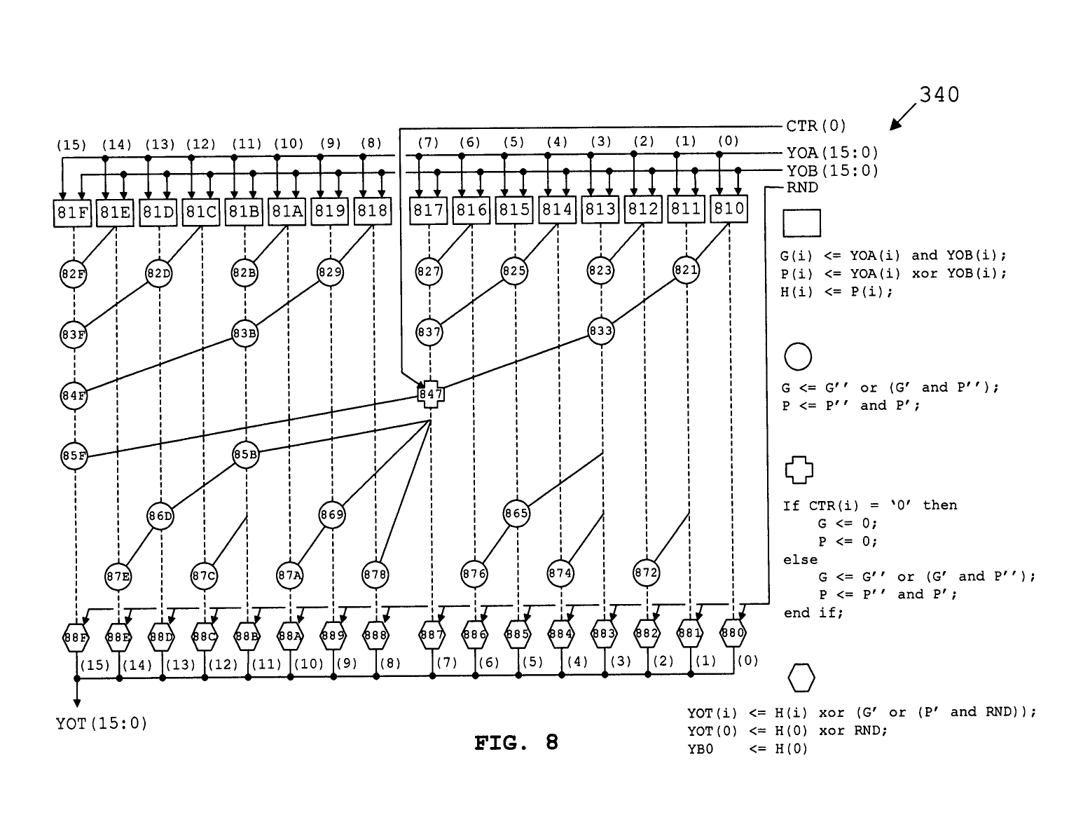

FIG. 8 illustrates a possible implementation of the partitioned carry propagate adder ADD 340 by modifying a standard Brent-Kung adder with generate and propagate logic circuit 847 placed on byte boundaries to cause the partitioning (16 bit example).

FIG. 8 illustrates an exemplary implementation of a SIMD instruction in ADD 340 by isolating two bytes through node 847. FIG. 8 shows ADD 340 implemented as a Brent-Kung carry look-ahead adder. In contrast to a ripple-carry adder, which is very slow and has to propagate the carry one bit at a time, carry look-ahead adders calculate for each position whether that position is going to propagate a carry if one comes in from the right. These calculated values are combined into groups to determine whether each group will propagate a carry. The addition of two bits is said to generate a carry if a carry is guaranteed, which is equivalent to an AND operation on the bits. The addition of two bits is said to propagate a carry if the addition of the two bits will carry whenever there is an input carry from the right, which is equivalent to the XOR operation on the two bits. A pair of bits will carry if either the addition of the bits generates a carry, or the next bit to the right (the next less significant bit) carries and the addition of the two bits propagates a carry. Thus, Cᵢ₊₁=Gᵢ OR (Pᵢ AND Cᵢ), where Cᵢ₊ is the carry in for the (i+1)-th bit, Gᵢ is whether the i-th bit generates, Pᵢ is whether the i-th bit propagates, and Cᵢ is the carry in for the i-th bit.

Two bytes are illustrated in FIG. 8. Adder nodes 810 through 81F add the individual bits of YOA and YOB. Each of nodes 810 through 81F generates a carry Gᵢ by ANDing the i-th bit of YOA and YOB, and propagates a carry Pᵢ by XORing the i-th bit of YOA and YOB. Look-ahead nodes 821 to 87E calculate whether a particular group of bits will carry. For example, look-ahead node 821 will calculate whether the result of the addition of the bits at adder node 811 and 810 will carry. Look-ahead node 833 calculates whether the group of bits from 810 to 813 will carry by taking as input the output of look-ahead nodes 821 and 823. Final adder nodes 880 through 88F add the i-th bit to the carry at that position. Final adder nodes 880-88F also add the value from the RND line, which is used to round in floating point operations and other functions that need a fast carry in. Also ZB0 output signal is generated as the least significant bit sum of YOA and YOB without the carry-in RND.

As explained above with reference to FIG. 7, node 847 of FIG. 8 acts to isolate the two bytes when CTR is set to “0”. It takes the place of the look-ahead node of the most significant bit of the byte section. If CTR bit is set to “0”, node 847 propagates “0”, thereby erasing the carry from the first byte and isolating bits (7:0) from bits (15:8). In this case, bits (7:0) and bits (15:8) are treated as separate pieces of data, allowing the execution of SIMD instructions. If CTR is set to “1”, node 847 acts as a regular look-ahead node and propagates the carry from look-ahead nodes 833 and 837.

### Data Path Segmentation

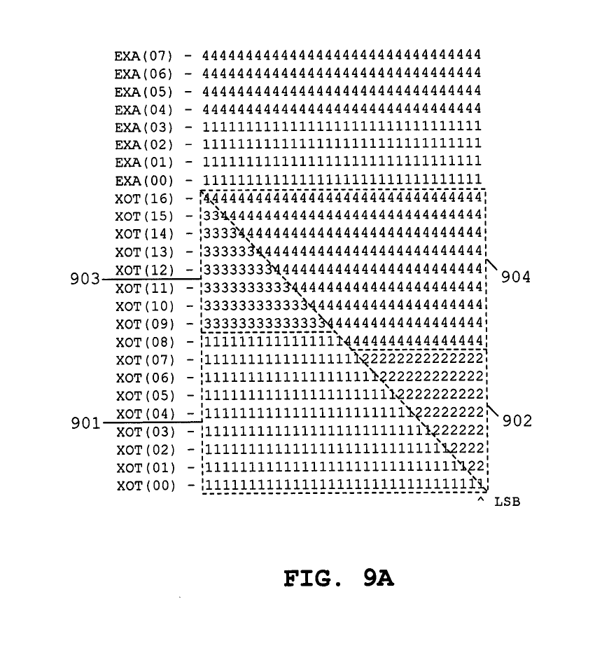

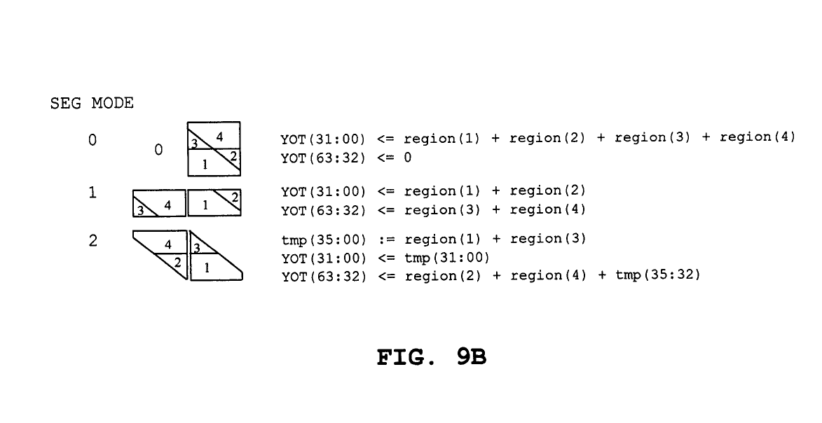

In addition to partitioning the adder into byte slices, WAL 330 and ADD 340 may be segmented into four regions to allow 64-bit results on a 32-bit EU in one cycle. FIG. 9A shows the four regions 1-4. How the XOT and EXA are added is determined by the segmentation control SEG 335. FIG. 9B shows 3 modes. Mode 0 used by most EU instructions is the simplest that takes all the input rows and totals them to produce a 32-bit result. Modes 1 and 2 are especially needed for single-cycle multiplication operations where the result width is double that of the input operand width. Mode 1 is used for byte and half multiply instructions by performing two 32-bit totals. The least significant 32-bit result is obtained by totaling regions 1 and 2. The most significant 32-bit result is obtained by totaling regions 3 and 4. Mode 2 is used for word multiply instructions by performing one 64-bit total. The least significant 32-bit result is obtained by totaling regions 1 and 3. The most significant 32-bit result is obtained by totaling regions 2 and 4 plus any carries from the least significant total.

### Finite-State Machine

The FSM 310 is the finite-state machine that controls data path blocks MUX 320, WAL 330 and ADD 340 as shown in FIG. 3. The FSM 310 interfaces with external circuitry and may generate the data path signals shown in Table 3.

TABLE 3

| SIGNAL | DESCRIPTION | DEFAULT VALUE |
|---|---|---|
| AXI | mux select input | AOP |
| BXI | mux select input | AOP |
| CXI | mux select input | BOP |
| PRG | mux program input | (others => (others => x”0”)) |
| CTR | adder byte slice control | (others => ‘1’) |
| SEG | adder segmentation control | 0 |
| EXA | extra adder inputs | (others => (others => ‘0’)) |
| RND | FP round carry in bit | 0 |
| ZOT | EU output | YOT |

The basic structure of FSM 310 is described in VHDL code listed in FIGS. 10A and 10B. Lines 01 to 09 set the default output values listed in Table 3. AXI 322 bus and BXI 323 bus are assigned the AOP operand and CXI 324 bus is assigned the BOP operand. Adder segmentation control SEG 335, floating point rounding RND 318, extra adder input EXA 332, and program line bus PRG 321 are all initially set to 0. The “others” command in the VHDL code is used to broadcast the value to all positions in the array. The “cyc” variable, used for multi-cycle instructions, is set to 0, and adder partitioning control CTR 334 is set for word scalar operation through the “111” value.

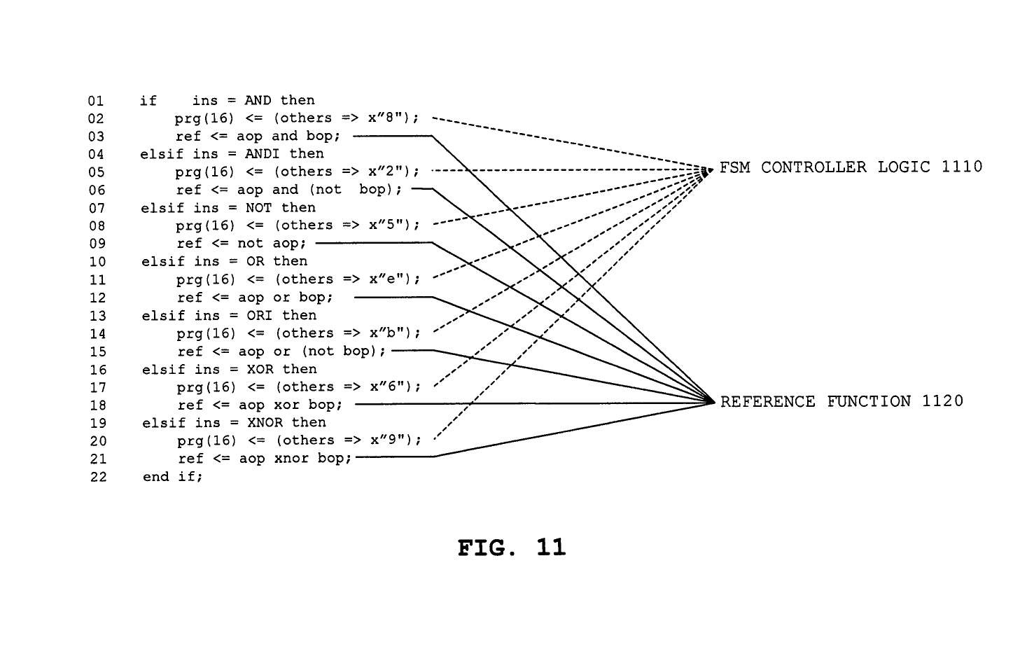

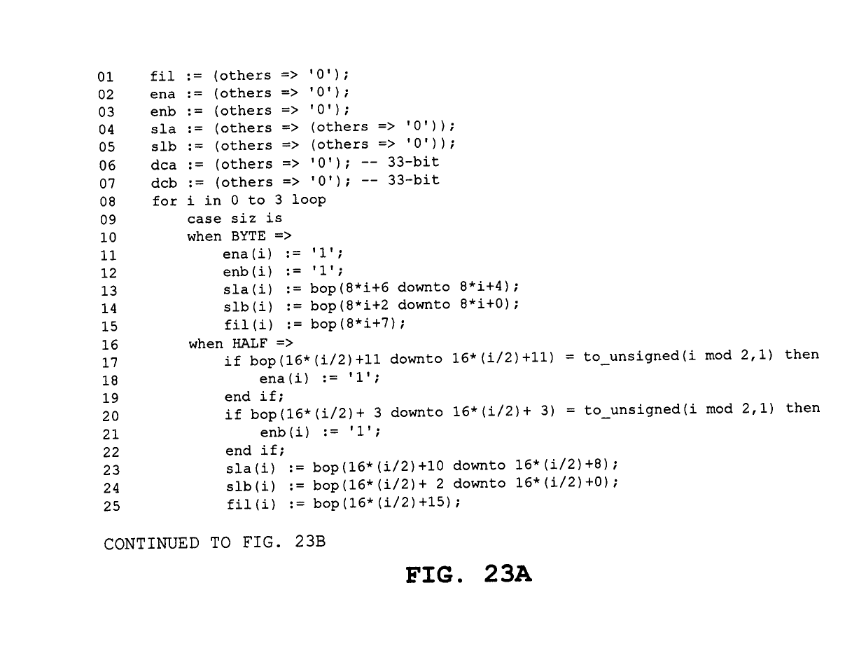

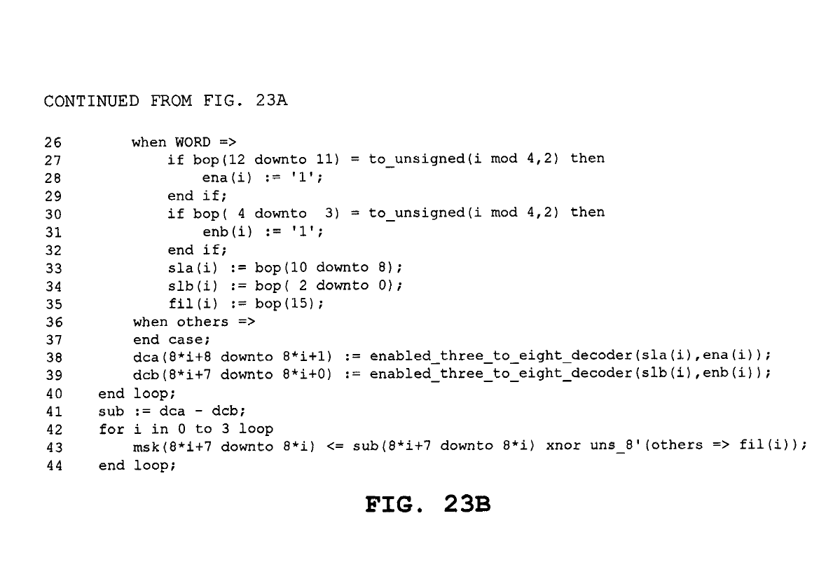

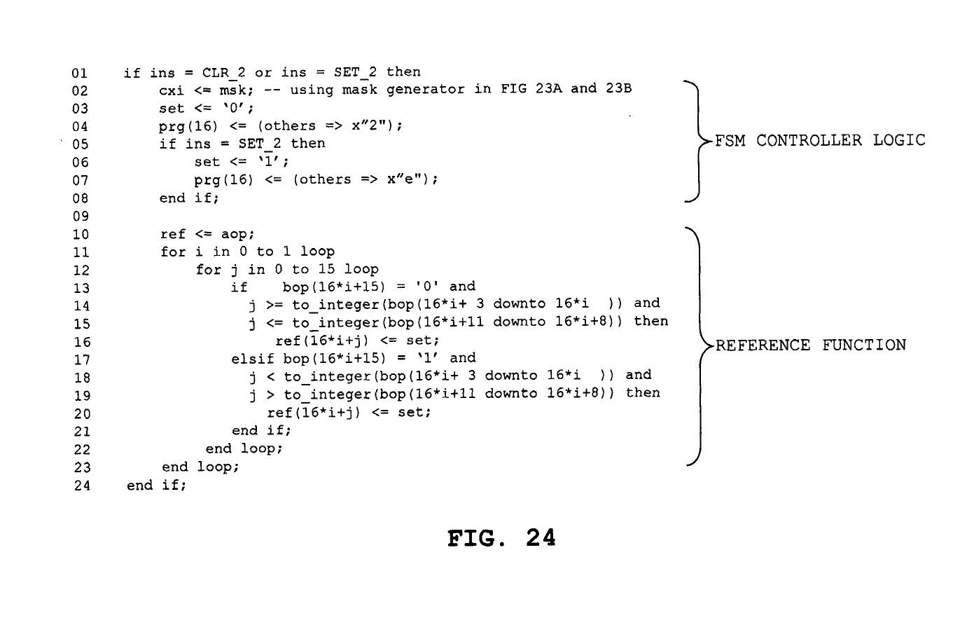

Line 11 implements a SIMD mask generator described below with reference to FIGS. 23A and 23B. The individual EU instruction follows as shown in Lines 13 to 15 for the AND instruction and Lines 17 to 19 for the BITR_4 instruction, etc. Exemplary VHDL code for individual instruction is listed in FIGS. 11 through 17B. Each instruction in VHDL code contains statements that override the defaults and set the output signals in Table 3 such that when XOT and EXA are totaled YOT is equal to the required result. Lines 25 to 50 perform floating-point rounding and post-rounding normalization for floating-point operations whereas Lines 51 to 55 send integer results YOT 342 to ZOT 317. Each instruction generates an expected result “ref” signal so that simulated actual and expected values can be checked by assertion on Line 57.

### Logical Operations

FIG. 11 shows exemplary VHDL code for implementing basic logic functions. For this class of instructions, the PRG line row 16 is assigned the same constant. The other rows have PRG set to 0 by default (FIG. 10A line 09). For example, for carrying out the AND instruction, the value “8” (“1000” in binary) is assigned to each 4-bit bus. As explained above with reference to FIG. 5 and FIG. 6B, the PRG buses act as the input to each multiplexer in the array and for the top row in FIG. 6B, the bits of the CXI bus are assigned to the msb select line of each MUX, and the bits of the BXI bus are assigned to the lsb select line of each MUX in row 16. Keeping in mind that by default AXI and BXI are assigned with the AOP operand and CXI is assigned with the BOP operand, each MUX will therefore use bits from the AOP and BOP operands to select one of the PRG lines. Since in the case of the AND operation, the value broadcast at the PRG line 16 of each MUX is “1000” in binary, the most significant bit, in this case carrying the value “1”, will only be selected if both the AOP and BOP bits are “1”. When the WAL 330 and ADD 340 total all of the XOT and EXA buses only XOT row 16 will contribute to the YOT results. Therefore, the result of using bits from the AOP and BOP operands to select the value “8” will be an AND operation on the AOP and BOP bits.

Similarly, for the OR operation, the PRG line broadcasts hexadecimal “e” (“1110” in binary). Therefore, the output of a MUX will be 1 unless both select lines are set to “0”. The result will be an OR operation on the AOP and BOP bits. The other logic functions are implemented in a similar manner. Assigning a value of “2” to the PRG line results in an ANDI operation on the AOP and BOP operands, assigning a value of “5” to the PRG line inverts the AOP operand, assigning the value hexadecimal “b” to the PRG line results in an ORI operation, assigning the value “6” to the PRG line results in a XOR operation on the AOP and BOP operands, and assigning the value of “9” to the PRG line results in an XNOR operation on the AOP and BOP operands.

For each instruction in FIG. 11, a reference function 1120 is provided. The reference function provides for a way to check the operation of the EU during design and testing, though it is not necessary for actual EU implementation.

### Addition and Subtraction

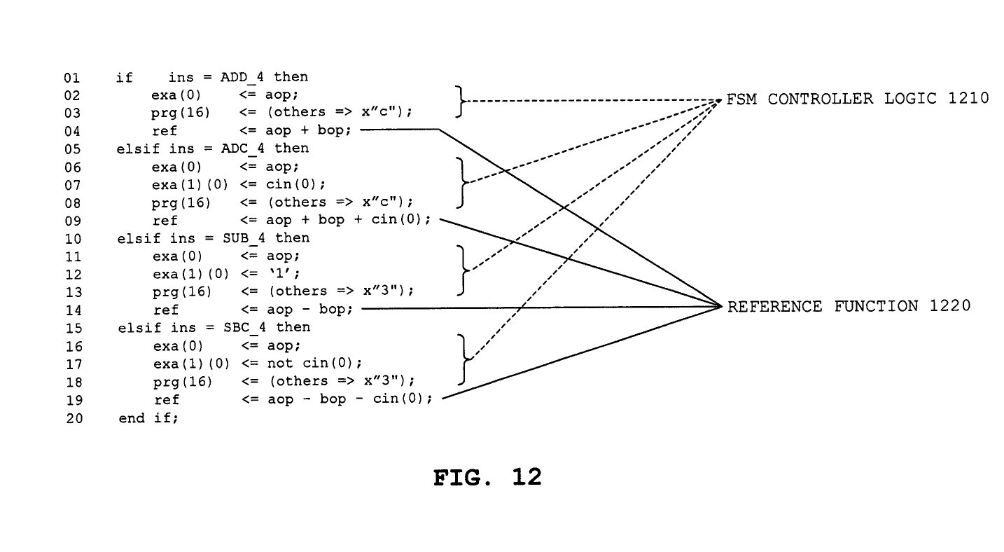

FIG. 12 shows exemplary VHDL code for the implementation of scalar addition and subtraction. With the four instructions, ADD_4, ADC_4, SUB_4 and SBC_4, the first operand AOP is assigned to EXA(0) shown in Lines 02, 06, 11 and 16.

For this class of instructions for FSM controller logic implementation 1210, the EXA(0) bus is assigned the AOP operand and the PRG bus row 16 is assigned the value hexadecimal “c” (“1100” in binary). Binary value “1100” as the input into a 4-to-1 MUX has the effect of propagating the value broadcast on the msb select line. As seen in FIG. 6B, for the top row of the MUX 320, msb select line is coupled to the CXI bus. Therefore, the PRG value of “c” has the net effect of propagating the BOP operand to the XOT(16) bus. As a result, the EXA(0) bus (carrying the AOP operand) and the XOT(16) bus (carrying the BOP operand), are added in WAL 330 and ADD 340. The end result is an AOP+BOP operation.

The ADC_4 instruction is an add operation with a carry in, where the carry in is assigned to the EXA(1)(0) bit. For the ADC_4 instruction, the operation is the same as ADD_4 except it includes Line 07, which causes the carry input, cin(0), to be added also.

The subtraction instruction is implemented by taking the 2's complement of the BOP operand and adding it to the AOP operand. The row 16 PRG value of “3” propagates the inverse of the BOP operand through the MUX 320. This has the result of assigning NOT BOP to the XOT(16) bus. Assigning “1” to the EXA(1) (0) bus leads to AOP+NOT(BOP)+1, which is the same as AOP−BOP.

Similarly, the SBC_4 instruction is a subtraction with a carry in, where the carry in is assigned to the EXA (1) (0) bit. The operation is the same as SUB_4 except it includes Line 17 which causes the inverted carry input, (not cin(0)), to be added to form the result ZOT=AOP−BOP−cin(0).

To perform the different vector addition and subtraction operations listed in Table 1, the CTR bus is set as in Table 2 along with EXA(1) for the proper carry input.

### Absolute Value

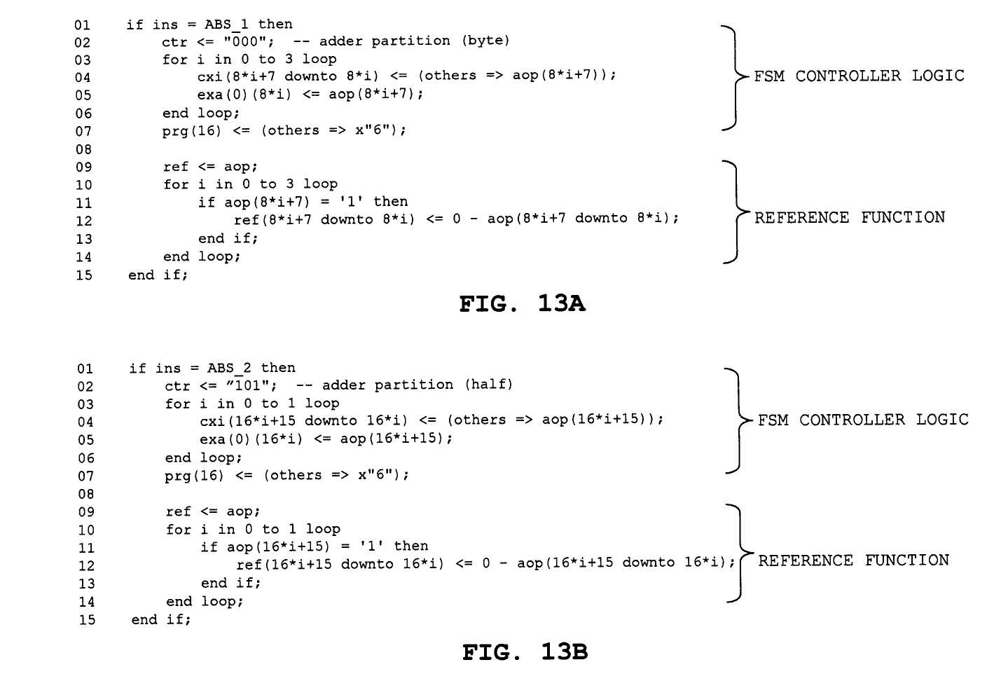

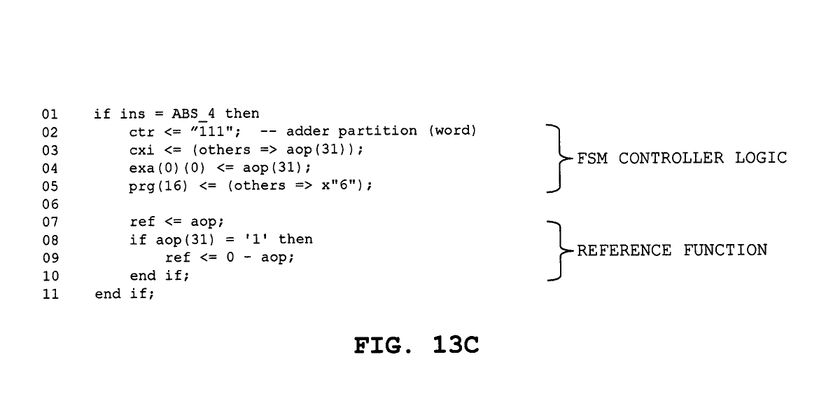

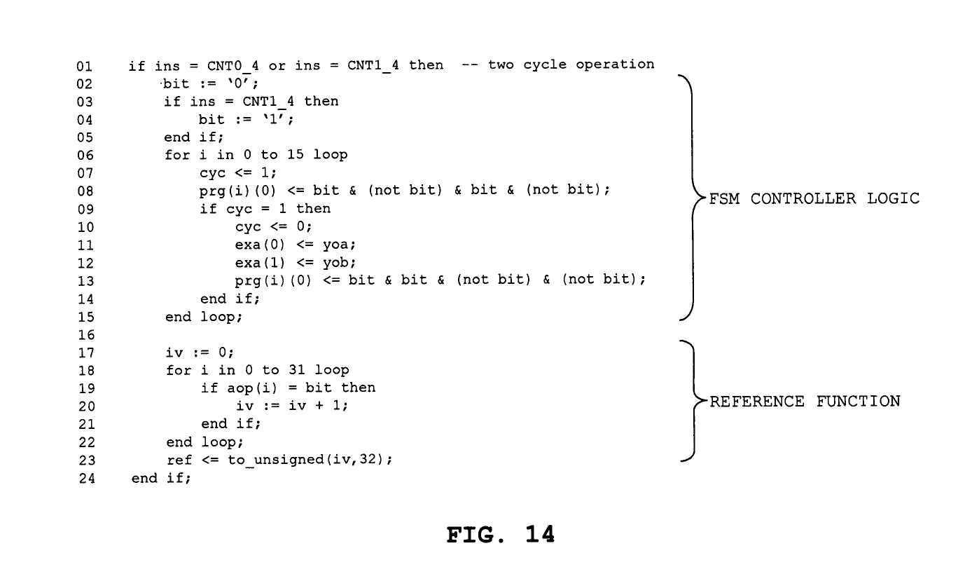

FIGS. 13A, 13B and 13C show exemplary VHDL code for implementing a byte vector, half vector and word scalar absolute value operations, respectively. The absolute value is calculated by

ZOT(i)<=AOP(i) when positive(AOP(i)) else 0−AOP(i);

Which is equivalent to

ZOT(i)<=AOP(i) when positive(AOP(i)) else not AOP(i)+1;

where i represents the i^{th} element of a vector or the only operand of a scalar.

The setting of the PRG line for absolute value instructions is shown in Table 4. In all these cases, PRG(16) is set to all 6's. The differences between FIGS. 13A, 13B and 13C are the CTR partition values, how the sign bits of the AOP(i) are broadcast to CXI and how an extra 1 is added when AOP(i) is negative.

TABLE 4

| sign(AOP(i)) | AOP(i) | SELECT | PRG(16) | XOT(16) | EXTRA 1 |
|---|---|---|---|---|---|
| + | 0 | 00 | 0 | AOT(i) | no |
| + | 1 | 01 | 1 | AOT(i) | no |
| − | 0 | 10 | 1 | not AOT(i) | yes |
| − | 1 | 11 | 0 | not AOT(i) | yes |

### Count Bits Instructions

FIG. 14 shows exemplary VHDL code for CNT1_4 instruction, which counts the number of ones in the AOP operand, and CNT0_4 instruction, which counts the number of zeros in the AOP operand. Each of these instructions executes in two cycles.

For the CNT1_4 instruction, with the first cycle (cyc=0), AOP's even “one” bits are totaled. During the second cycle (cyc=1), AOP's odd “one” bits are added to the accumulated total in EXA(0) and EXA(1) Lines 11 and 12. ADD 340 generates the final total at the end of the second cycle. The CNT0_4 instruction is similarly calculated, except the number of zeros in AOP is totaled.

### Vector Sum

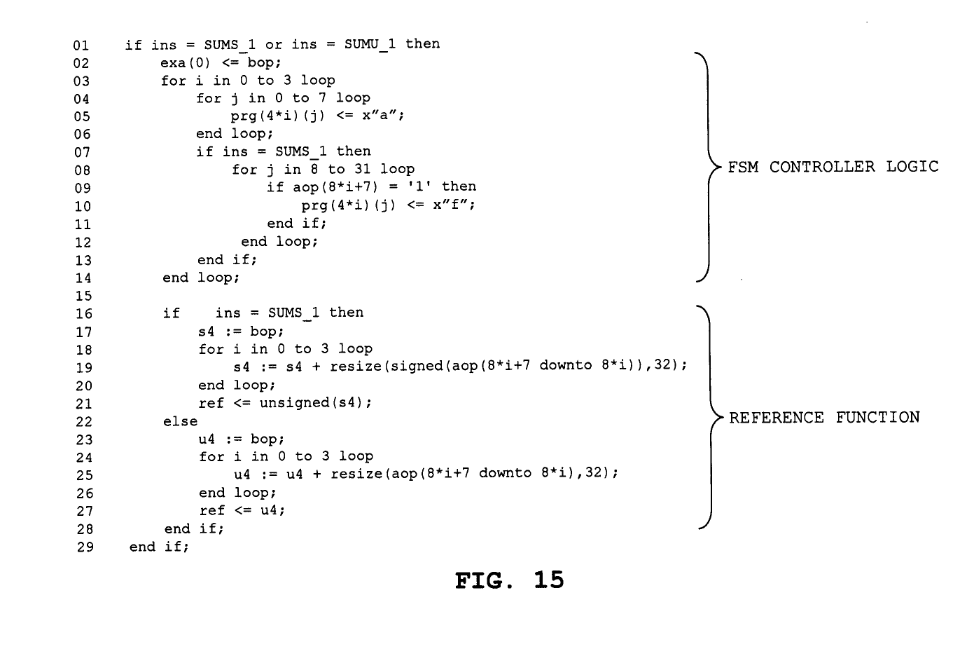

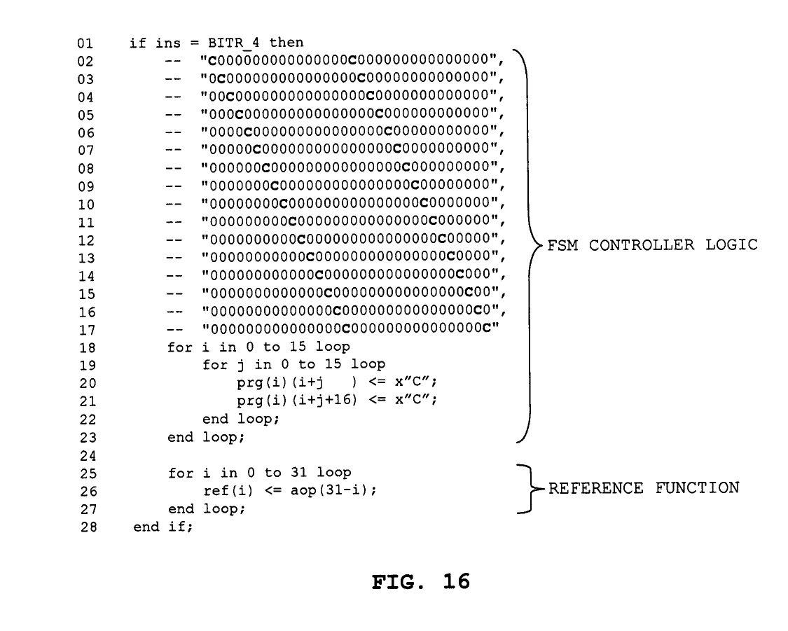

FIG. 15 shows the exemplary VHDL code for calculating byte vector sums. SUMS_1 calculated the signed byte vector sum and SUMU_1 calculates the unsigned byte vector sum. The SUMU_1 instruction performs an unsigned byte vector operation as follows.

ZOT<=BOP+AOP(3)+AOP(2)+AOP(1)+AOP(0);

Line 02 causes BOP to be added to the total. Lines 04-06 cause the properly aligned byte operands to be added. The SUMS_1 instruction is also covered in FIG. 15. It includes all of the SUMU_1 code and has additional statements on Lines 07-13 that sign extends the AOP byte operands.

ZOT<=BOP+resize(AOP(3),32)+resize(AOP(2),32)+resize(AOP(1),32)+resize(AOP(0),32);

### Bit Reverse

FIG. 16 shows the exemplary VHDL code for executing a bit reverse instruction. The BITR_4 bit reverse instruction performs the following function.

ZOT(31 downto 0)<=AOP(0 to 31);

With this instruction, comment lines 02-17 show the regular pattern of PRG assignment. The MUX 320 select connections shown in FIG. 6B help in understanding the pattern. BITR_1 and BITR_2 have a similar pattern. The sparse nature of the PRG pattern seen here is common with most EU instructions.

### Shift/Rotate

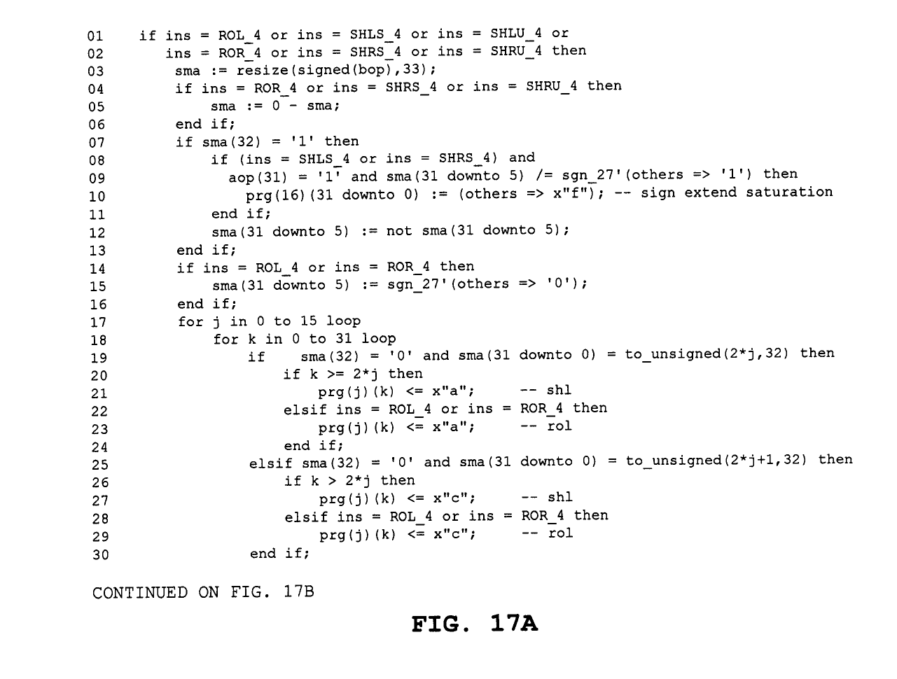

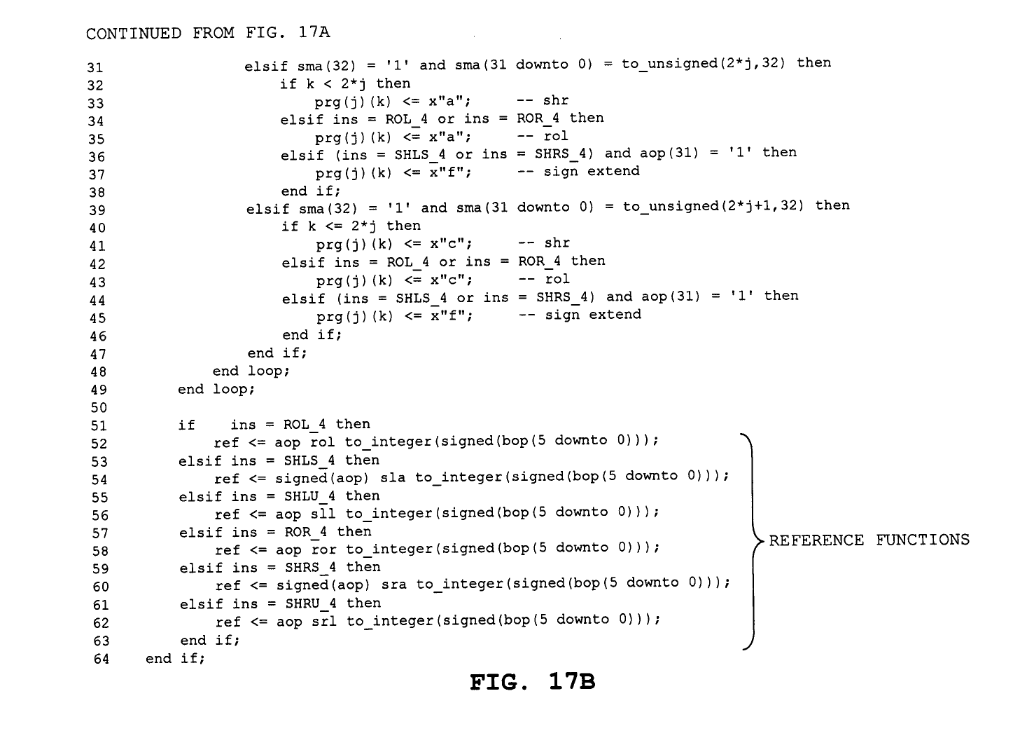

FIG. 17A and FIG. 17B show exemplary VHDL code for implementing shift and rotate instructions. Similar code can implement byte and half vector shift/rotate operations. The BOP shift amount is signed so that negative shifts cause the instruction to shift/rotate in the opposite direction by the absolute value of BOP. Lines 03-16 form the effective shift/rotate amount SMA. Right shift/rotate operations are performed by left shift/rotate by 0−BOP with Lines 04-06. Sign extension saturation occurs during signed shifts with large shift amounts with Lines 08-11. Lines 14-16 cause rotates to be concerned only with the BOP's least significant 5 bits.

For shifts, the lower left MUX triangle LOL 620 (shown in FIG. 6B) is set during positive even (Line 21) or during positive odd (Line 27) effective shifts. Similarly, the upper right MUX triangle UPR 630 (shown in FIG. 6B) is set during negative even (Line 33) or during negative odd (Line 41) effective shifts. For signed shifts, the LOL triangle can sign extend when necessary (Lines 37, 45).

For rotates, both the UPR and LOL triangles are set during positive even (Line 23) or during positive odd (Line 29) or during negative even (Line 35) or during negative odd (Line 43) effective rotates.

### Multiplication

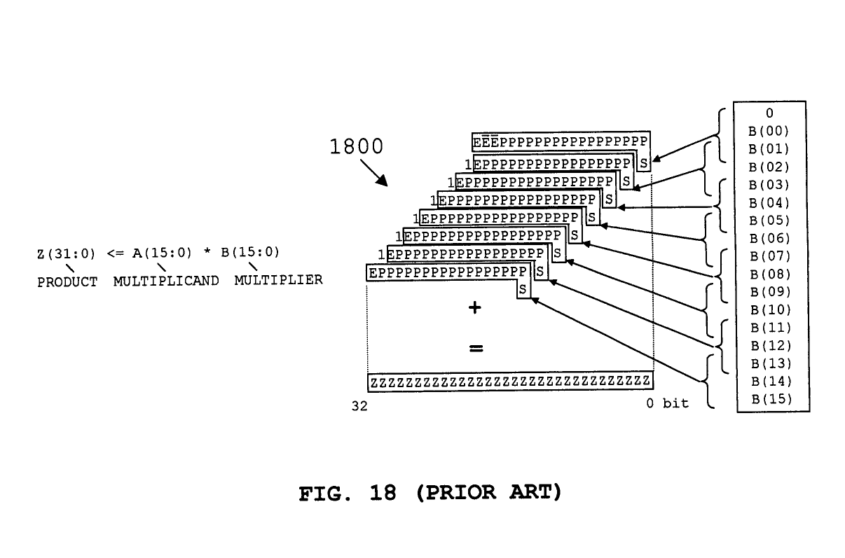

FIG. 18 shows a conventional Booth multiplication algorithm. A 16-by-16 bit signed multiply 1800 is constructed by generating the partial products shown in Table 5. By using Booth's algorithm, the partial products are shifted left two bits per row. This allows the multiplication to be calculated with only eight additions. Larger or smaller multipliers can be similarly formed.

TABLE 5

| MULTIPLIER BITS | M-BIT | E-BIT | S-BIT | P-BITS |
|---|---|---|---|---|
| 000 | 0 | 1 | 0 | +0 |
| 001 | A(15) | not A(15) | 0 | +A |
| 010 | A(15) | not A(15) | 0 | +A |
| 011 | A(15) | not A(15) | 0 | +2*A |
| 100 | not A(15) | A(15) | 1 | −2*A |
| 101 | not A(15) | A(15) | 1 | −A |
| 110 | not A(15) | A(15) | 1 | −A |
| 111 | 0 | 1 | 0 | −0 |

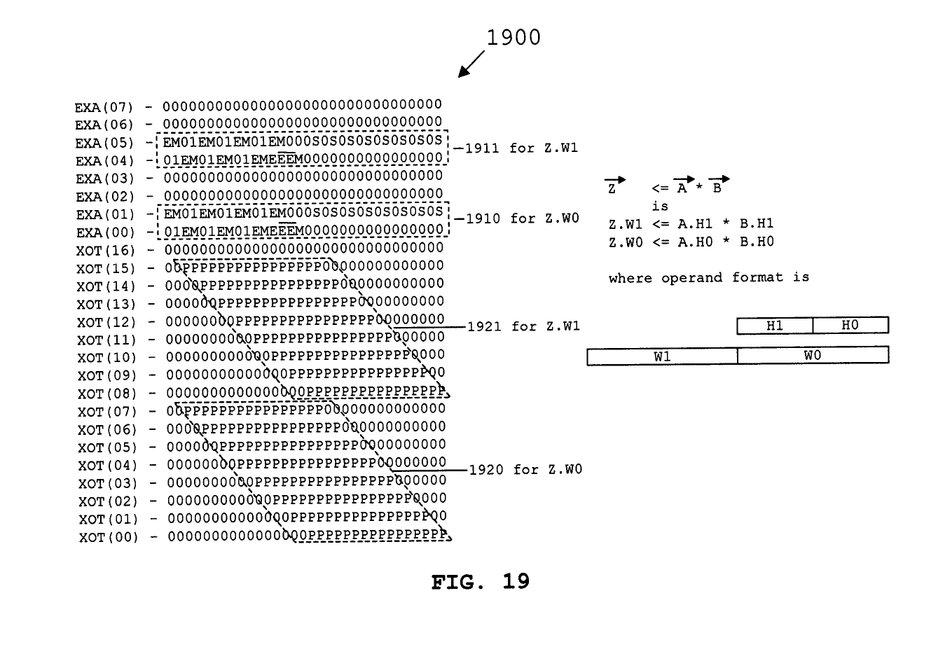

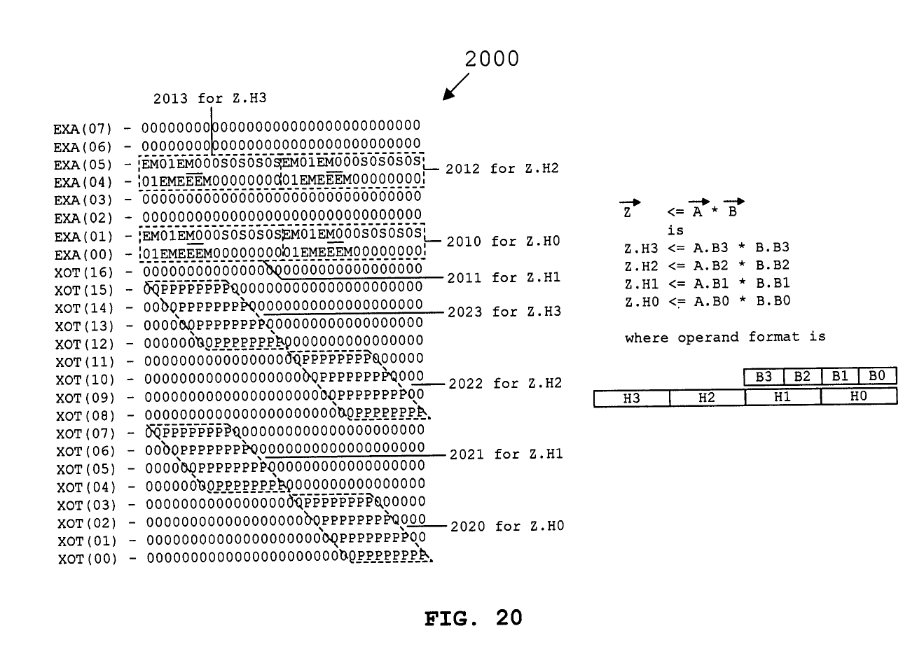

FIG. 19 shows how signed half vector multiplication can be performed by overlaying the Booth's partial product pattern 1800 on the WAL 330, XOT and EXA input buses. The overlay occurs twice, one time for the Z.W0 product (1910 and 1920) and one time for the Z.W1 product (1911 and 1921). Note that the top row of 1800 is actually the bottom row XOT(00) or XOT(08). The overlays are aligned to directly produce the results. As shown, the M, E and S bits of 1800 are collected together in EXA inputs (1910 and 1911). This is just one example, and any pattern that adds these bits in the correct columns is acceptable. By using WAL 330 and ADD 340 with Segmentation Mode 1 from FIG. 9B, the EU can calculate the entire 64 bit result in a single cycle.

Similar to FIG. 19, FIG. 20 shows how signed byte vector multiplication can be performed by overlaying an 8-by-8 bit pattern of partial products according to the Booth algorithm on WAL 330, XOT and EXA input buses. The overlay occurs four times, one time for the Z.H0 product (2010 and 2020), one time for the Z.H1 product (2011 and 2021), one time for the Z.H0 product (2012 and 2022), and one time for the Z.H3 product (2013 and 2023). The overlays are aligned to directly produce the results. As shown, the M, E and S bits of 1800 are collected together in EXA inputs (2011-2013). This is just one example, and any pattern that adds these bits in the correct columns is acceptable. By using WAL 330 and ADD 340 with Segmentation Mode 1 from FIG. 9B, the EU can calculate the entire 64-bit result in a single cycle.

### Complex Multiply Accumulate

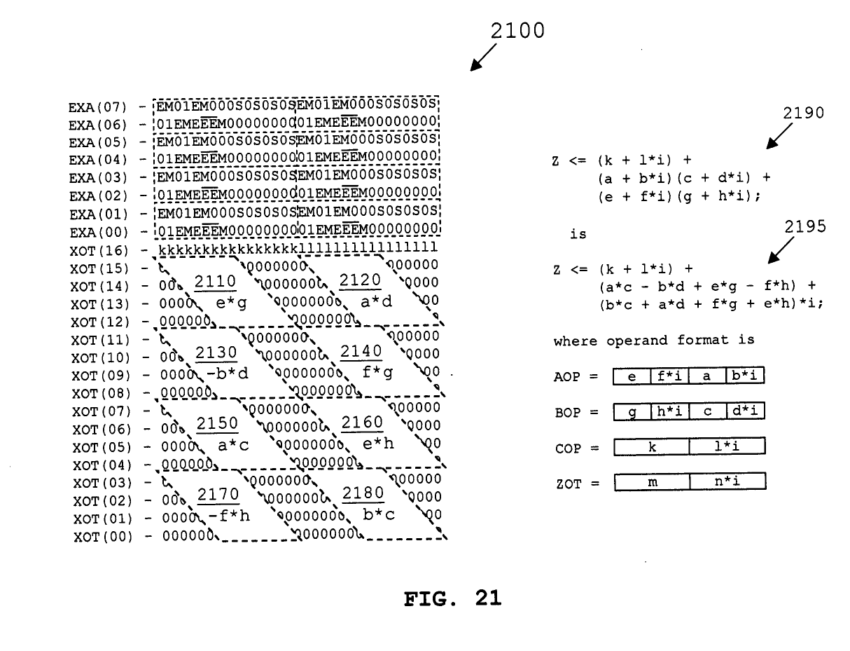

FIG. 21 illustrates how complicated EU operations can be implemented. In this example, a complex byte vector multiply accumulate 2190, which shows the definition of complex multiplication, is expanded in 2195. The partial products from expanded expression 2195 are overlaid onto WAL 330 inputs, the EXA and XOT buses, by overlaying Booth patterns according to structure 2100 shown in FIG. 21. The AOP input and ZOT output vector operands are then correctly aligned for the calculation.

### Mask Unit and Bit Set/Clear Instructions

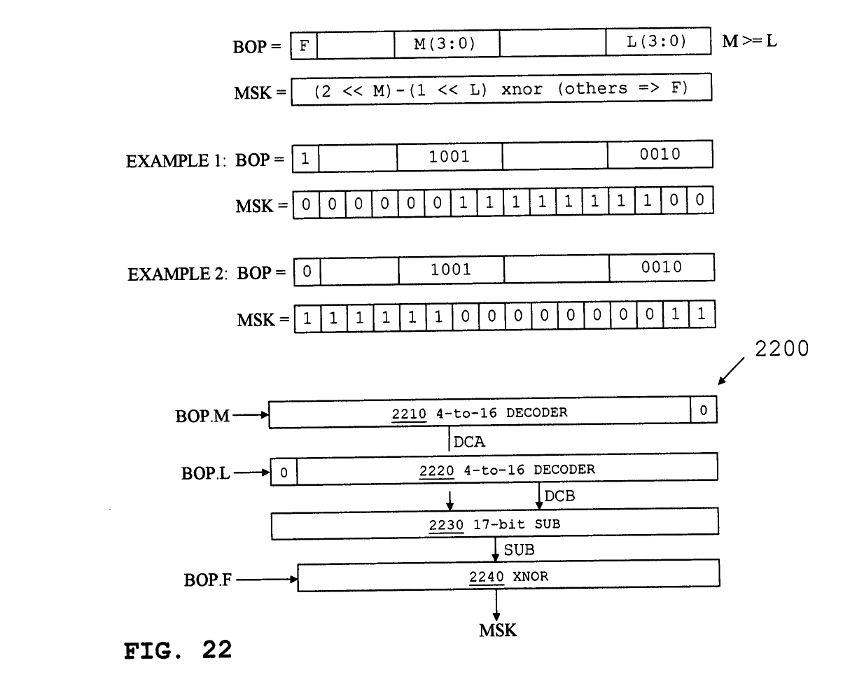

For use in bit field set and clear operations SET_1, SET_2, SET_4, CLR_1, CLR_2 and CLR_4, a vector mask generator is implemented as shown by exemplary VHDL code in FIGS. 23A and 23B. To explain the vector mask unit operation, first a simpler 16-bit scalar mask unit is shown FIG. 22. The mask is generated from three BOP fields: F=fill value, M=most significant, L=least significant. If F=1, the mask output MSK is all ones between bit M and bit L inclusive, otherwise MSK is all zeros between bit M and bit L. Examples 1 and 2 of FIG. 22 illustrate the mask unit operation. For proper operation, M must be greater than or equal to L. An exception will occur if this is not the case.

The mask unit 2200 circuit contains a 4-to-16 bit decoder for the M field 2210, a 4-to-16 bit decoder for the L field 2220, a subtractor SUB 2230 and XNOR 2240 gates. The subtract operand DCA is shifted left one bit when compared to the DCB operand. The XNOR 2240 gates are used to flip the SUB 2230 output according to the fill value F.

Mask 2200 may be implemented within the finite state machine of the execution unit. Mask 2200 may be implemented separate from the finite state machine. While FIG. 22 illustrates a mask implemented for a 16-bit EU, the mask may be implemented for any n-bit EU. For an EU with n bits, M field decoder 2210 may be a log 2 (n)-to-n decoder, L field decoder 2220 may be an log 2(n)-to-n decoder, subtractor 2230 may be a n+1 bit subtractor, and XNOR gate component 2240 may be comprised of n XNOR gates.

To accommodate vector operations, the mask unit is modified as shown in FIGS. 23A and 23B. The decoders are replaced with enabled 3-to-8 bit decoders at Lines 38 and 39, and the subtractor Line 41 is widened to 33 bits, and the xnor gates are controlled by byte-wise fill values at Lines 42-44. For byte vector masks, the code at Lines 10-15 generates the necessary select/enable decoder inputs and fill values. Similarly for half vector masks, the code at Lines 16-25 generates the necessary select/enable decoder inputs and fill values. For word scalar masks, the code at Lines 26-35 generates the necessary select/enable decoder inputs and fill values.

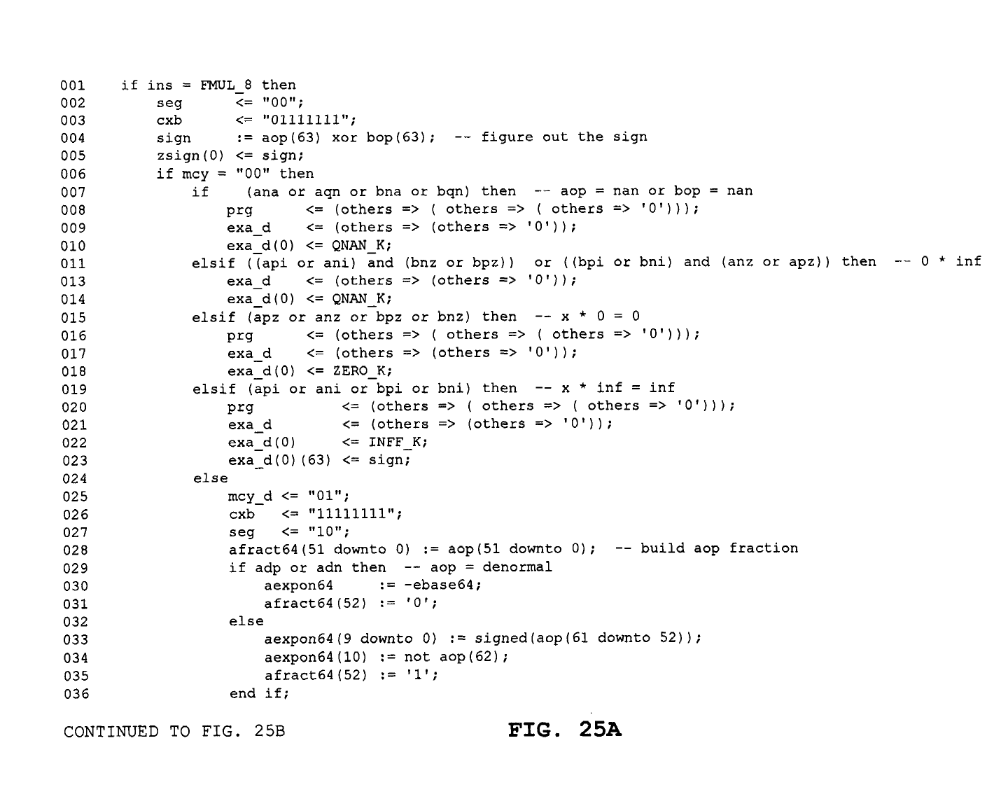

FIG. 24 shows exemplary VHDL code for an implementation of FSM 310 to support bit field clear and set operations. Once the vector mask generator is implemented, the bit field set and clear operations are simple. First the mask unit output must drive the CXI bus, as shown at Line 02 of FIG. 24. Then for set operations, PRG(16) is driven with all “e” hexadecimal, as shown at Line 07. For clear operations PRG(16) is driven with all “2”, as shown at Line 04.

### Floating-Pount Multiply

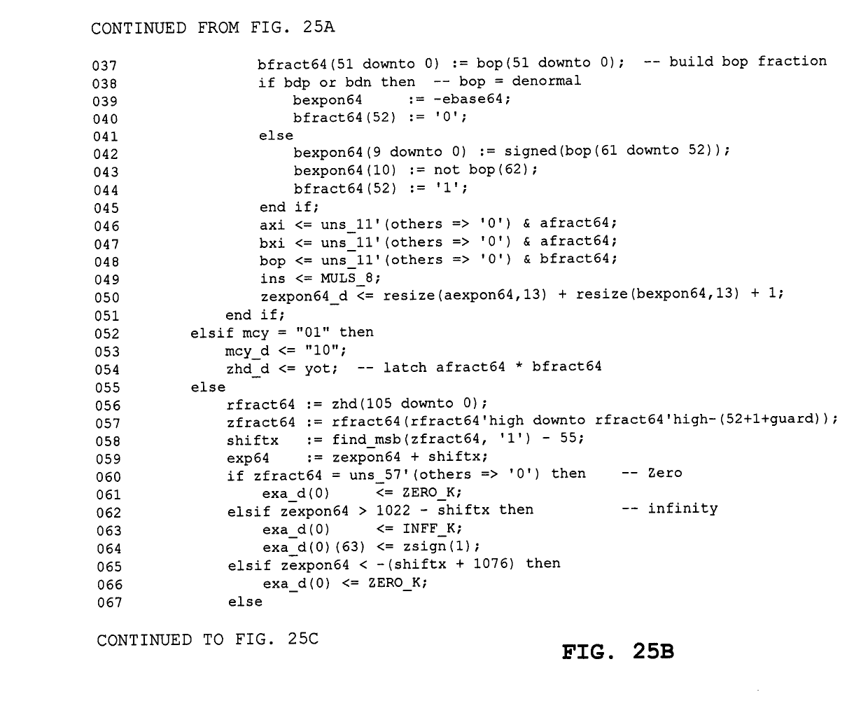

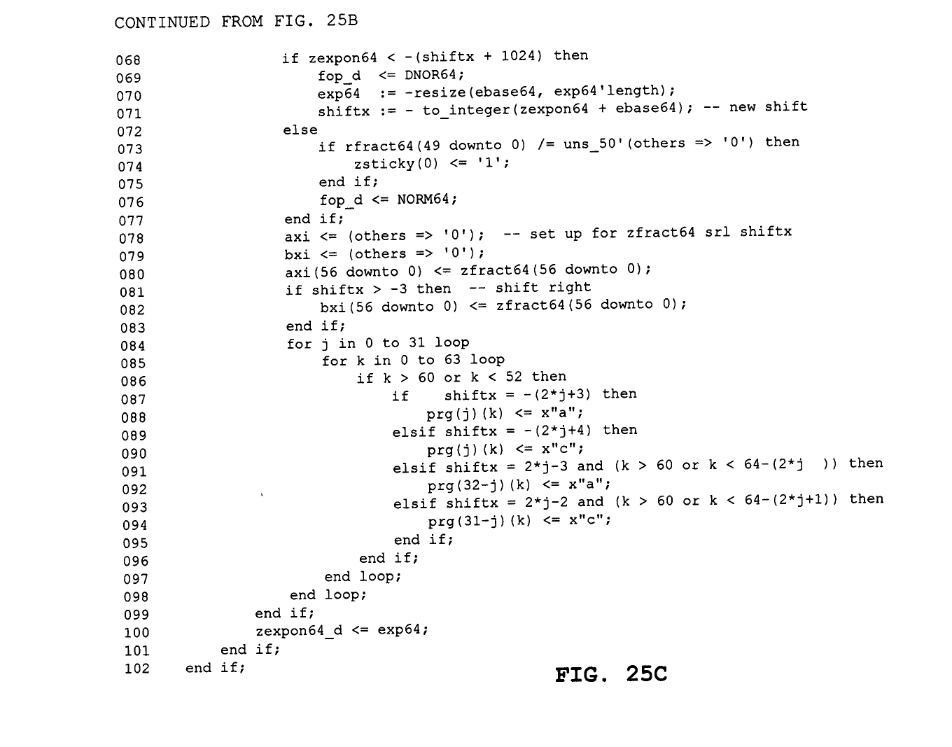

The EU can perform floating-point operations. For example, exemplary VHDL code for a double precision floating-point multiply instruction FMUL_8 is coded as shown by the exemplary VHDL code in FIGS. 25A, 25B, 25C, and FIG. 10B, Lines 26-50. The FMUL_8 instruction takes three cycles to complete.

Special cases such as AOP=“not a number” (NAN); BOP=NAN; 0.0*∞; AOP*0.0; BOP*0.0; AOP*∞; or BOP*∞ are coded as shown in Lines 007-023. Lines 028-036 form the AOP fraction AFRACT64 for normal and denormal numbers. Similarly, Lines 037-045 form the BOP fraction BFRACT64. The signed integer multiply MULS_8 is performed with AFRACT64 and BFRACT64 as shown in Lines 046-049. The multiplication result is captured and held in ZHD during the second cycle, as shown in Lines 053 and 054. The shift amount that the resulting fraction ZFRACT64 needs to be shifted to the right is calculated on Line 058. Special cases such as ZFRACT64=0; results=∞; or results<denormal number are coded in Lines 060-066. Lines 068-077 determine whether the result is either a normal or denormal number. Lines 078-099 perform a right shift of ZFRACT64(55 downto 3) and a right rotate of ZFRACT64(2 downto 0). The final FMUL_8 result is calculated as shown in FIG. 10B, Lines 26-50, where rounding is performed on Lines 27-36 and post-rounding normalization occurs on Lines 37-46.

### Optimizing the EU

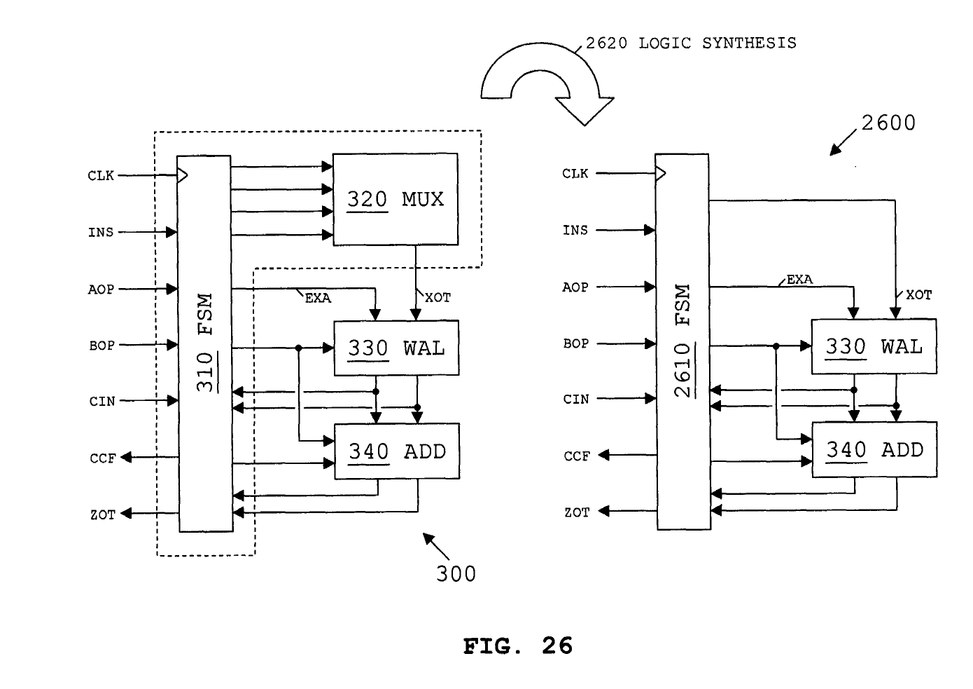

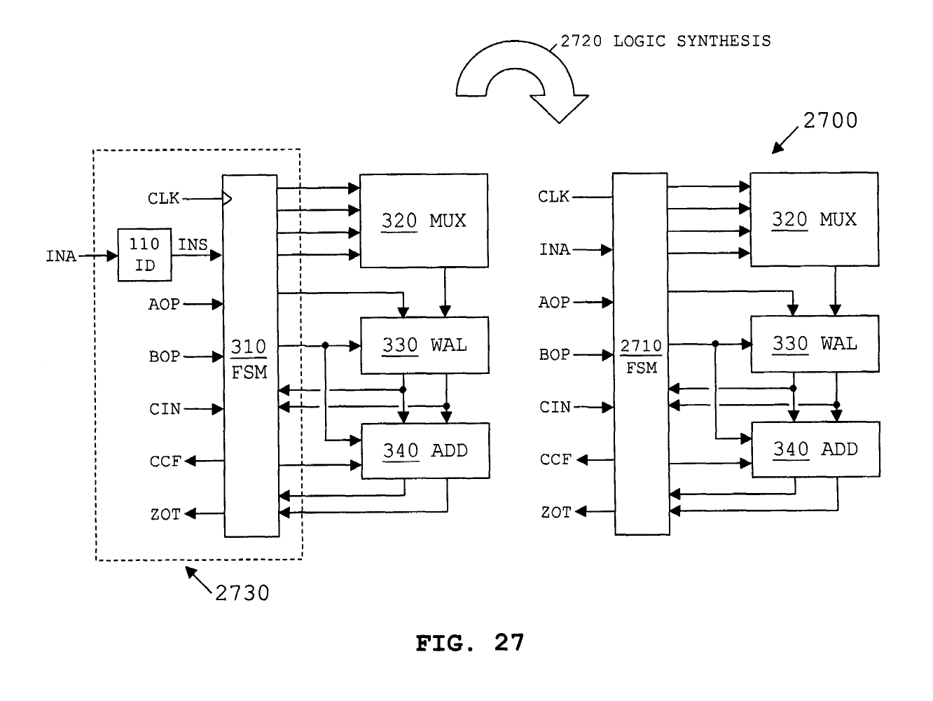

Through the use of logic synthesis, the timing, area and power consumption of the EU 300 can be optimized. The individual blocks FSM 310, MUX 320, WAL 330, and ADD 340 can be optimized separately and/or the entire circuit can be optimized. Flattening some or all of the hierarchy can further optimize the circuit. For example, in FIG. 26 the FSM 310 and MUX 320 are flattened and optimized into a new logic-reduced FSM 2610. This circuit directly generates XOT signals. In FIG. 27, the instruction decoder ID 110 is flattened with the FSM 310 to form the logic-reduced FSM 2710. Alternately, instruction decoder ID 110, FSM 310, and MUX 320 can be flattened and optimized. In addition to logic optimization, standard pipelining techniques can be used to increase EU throughput.

While circuits and physical structures are generally presumed, it is well recognized that in modern semiconductor design and fabrication, physical structures and circuits may be embodied in computer readable descriptive form suitable for use in subsequent design, test or fabrication stages as well as in resultant fabricated semiconductor integrated circuits. Accordingly, claims directed to traditional circuits or structures may, consistent with particular language thereof, read upon computer readable encodings and representations of same, whether embodied in media or combined with suitable reader facilities to allow fabrication, test, or design refinement of the corresponding circuits and/or structures. The invention is contemplated to include circuits, related methods or operation, related methods for making such circuits, and computer-readable medium encodings of such circuits and methods, all as described herein, and as defined in the appended claims. As used herein, a computer-readable medium includes at least disk, tape, or other magnetic, optical, semiconductor (e.g., flash memory cards, ROM), or other electronic medium. An encoding of a circuit may include circuit schematic information, physical layout information, behavioral simulation information, and/or may include any other encoding from which the circuit may be represented or communicated.

An embodiment of the invention may also be included in a kit-of-parts. The kit-of-parts may include some, or all, of the components that an embodiment of the invention includes. The kit-of-parts may be an in-the-field retrofit kit-of-parts to improve existing systems that are capable of incorporating an embodiment of the invention. The kit-of-parts may include software, firmware and/or hardware for carrying out an embodiment of the invention. The kit-of-parts may also contain instructions for practicing an embodiment of the invention. Unless otherwise specified, the components, software, firmware, hardware and/or instructions of the kit-of-parts can be the same as those used in an embodiment of the invention.

### Advantages

Embodiments of the invention can be cost effective and advantageous for at least the following reasons. Embodiments of the invention improve quality and/or reduce costs compared to previous approaches. The foregoing need for complex EU operations with reduced circuit size and power consumption along with optimal timing is satisfied by this approach to EU design. Using synthesis, simulation and power estimation tools, the present invention demonstrates measurably significant advances in all metrics as shown in Table 6 below (for a 64 bit EU). Because the power requirement is only one-fifth that of a conventional EU, many applications become viable including next-generation mobile handsets known as software-defined radio (SDR) for military, homeland security agencies, emergency responders and commercial users.

TABLE 6

| | CONVENTIONAL | PROPOSED | |
|---|---|---|---|
| METRIC | EU | EU | ADVANTAGE |
| POWER | 383 | 76.1 | 503% |
| CONSUMPTION | | | |
| (mW) | | | |
| AREA | 197 | 112 | 176% |
| (K gates) | | | |
| TIMING | 32.7 | 31.4 | 104% |
| (nanoseconds) | | | |

### DEFINITIONS

The term program and/or the phrase computer program are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system).

The term substantially is intended to mean largely but not necessarily wholly that which is specified. The term approximately is intended to mean at least dose to a given value (e.g., within 10% of). The term generally is intended to mean at least approaching a given state. The term coupled is intended to mean connected, although not necessarily directly, and not necessarily mechanically. The term proximate, as used herein, is intended to mean close, near adjacent and/or coincident; and includes spatial situations where specified functions and/or results (if any) can be carried out and/or achieved. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), or both A and B are true (or present). The terms a or an are employed for grammatical style and merely for convenience.

The term plurality is intended to mean two or more than two. The term any is intended to mean all applicable members of a set or at least a subset of all applicable members of the set. The phrase any integer derivable therein is intended to mean an integer between the corresponding numbers recited in the specification. The phrase any range derivable therein is intended to mean any range within such corresponding numbers. The term means, when followed by the term “for” is intended to mean hardware, firmware and/or software for achieving a result. The term step, when followed by the term “for” is intended to mean a (sub)method, (sub)process and/or (sub)routine for achieving the recited result.

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. The terms “consisting” (consists, consisted) and/or “composing” (composes, composed) are intended to mean closed language that does not leave the recited method, apparatus or composition to the inclusion of procedures, structure(s) and/or ingredient(s) other than those recited except for ancillaries, adjuncts and/or impurities ordinarily associated therewith. The recital of the term “essentially” along with the term “consisting” (consists, consisted) and/or “composing” (composes, composed), is intended to mean modified close language that leaves the recited method, apparatus and/or composition open only for the inclusion of unspecified procedure(s), structure(s) and/or ingredient(s) which do not materially affect the basic novel characteristics of the recited method, apparatus and/or composition.

Unless otherwise defined, all technical and scientific terms used herein have the same meaning as commonly understood by one of ordinary skill in the art to which this invention belongs. In case of conflict, the present specification, including definitions, will control.

### CONCLUSION

The described embodiments and examples are illustrative only and not intended to be limiting. Although embodiments of the invention can be implemented separately, embodiments of the invention may be integrated into the system(s) with which they are associated. All the embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences. The individual components of embodiments of the invention need not be formed in the disclosed shapes, or combined in the disclosed configurations, but could be provided in any and all shapes, and/or combined in any and all configurations. The individual components need not be fabricated from the disclosed materials, but could be fabricated from any and all suitable materials. Homologous replacements may be substituted for the substances described herein. Agents that are both chemically and physiologically related may be substituted for the agents described herein where the same or similar results would be achieved.

It can be appreciated by those of ordinary skill in the art to which embodiments of the invention pertain that various substitutions, modifications, additions and/or rearrangements of the features of embodiments of the invention may be made without deviating from the spirit and/or scope of the underlying inventive concept. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A device comprising:
a finite state machine comprising:
an instruction input;
a plurality of operand inputs;
a plurality of outputs;
a plurality of extra adder inputs;
a result output; and
condition code output flags;
an array of multiplexers coupled to the plurality of outputs and comprising a plurality of multiplexer outputs;
a carry-save adder tree coupled to the plurality of multiplexer outputs and coupled to the extra adder inputs and comprising a plurality of carry-save adder tree outputs coupled to the finite state machine; and
a carry-propagate adder coupled to the plurality of carry-save adder tree outputs and comprising a plurality of carry-propagate adder outputs coupled to the finite state machine.

2. The device of claim 1, where the carry-save adder tree comprises a Wallace adder configured for single instruction multiple data operation.

3. The device of claim 2, where the finite state machine further comprises an adder partition output that controls the carry-save adder tree by isolating individual vector elements in single instruction multiple data operations.

4. The device of claim 1, where the carry-propagate adder comprises a Brent-Kung adder configured for single instruction multiple data operation.

5. The device of claim 4, where the finite state machine further comprises an adder partition output that controls the Brent-Kung adder by isolating individual vector elements in single instruction multiple data operations.

6. The device of claim 1, where the device is configured for operands having n bits, where each multiplexer in the array of multiplexers comprises a 4-to-1 multiplexer and where the array of multiplexers has (n/2+1) rows and n columns.

7. The device of claim 1, where the finite state machine further comprises a carry in input line, a carry out output line, a dock input line, and a rounding line coupled to the carry-propagate adder.

8. The device of claim 1, where the plurality of outputs comprises a program line, a first select input line, a second select input line, and a third select input line.

9. The device of claim 8, where each of the plurality of operand inputs, the first select input line, the second select input line, the third select input line, the plurality of extra adder inputs, and the result output each comprises n bits, and where the program line comprises (n/2+1) rows of n columns of 4 bit buses.

10. The device of claim 6, where n comprises one of 8, 16, 32, 64, or 128.

11. The device of claim 9, where the j-th 4-bit bus in the i-th row of the program line is coupled to data inputs of the j-th multiplexer in the i-th row.

12. The device of claim 9,
where first select line of the i-th row j-th multiplexer is coupled to the first select line bit ((n−2*i+j)mod n) for all 0≦i<n/2, 0≦j<n, 2*i≦j, and
where second select line of the i-th row j-th multiplexer is coupled to the first select line bit ((n−2*i−1+j)mod n) for all 0≦i<n/2, 0≦j<n, 2*i+1≦j, and
where first select line of the i-th row j-th multiplexer is coupled to the second select line bit ((n−2*i+j)mod n) for all 0≦i≦n/2, 0≦j≦n, 2*i>j, and
where second select line of the i-th row j-th multiplexer is coupled to the second select line bit ((n−2*i−1+j)mod n) for all 0≦i<n/2, 0≦j<n, 2*i+1>j, and
where first select line of the n-th row j-th multiplexer is coupled to the second select line bit (j) for all 0≦j<n and
where second select line of the n-th row j-th multiplexer is coupled to the third select line bit (j) for all 0≦j<n.

13. The device of claim 9, where the finite state machine is configured to output a set of predetermined values on the program line based on an instruction received at the instruction input, and where the finite state machine is configured to output an operand received at one of the plurality of operand inputs on each of the first select input line, the second select input line, and the third select input line.

14. The device of claim 1, where the finite state machine is configured to execute one or more of single instruction multiple data instructions including: logic, addition, subtraction, absolute value, count the number of zeros, count the number of ones, bit reverse, rotate, shift, set, clear, multiply, complex multiply accumulate, floating-point multiply, and vector sum instructions.

15. The device of claim 1 configured to execute integer operations and floating-point operations through the same data path.

16. The device of claim 1, where the carry-save adder tree and carry-propagate adder are segmented so as to execute wide multiplication instructions in one clock cycle.

17. The device of claim 16, where the finite state machine and the array of multiplexers are configured to execute vector multiplication instructions by assigning partial products to the multiplexer outputs and the extra adder inputs.

18. The device of claim 1, where the finite state machine further comprises a vector mask generator.

19. The device of claim 18, where the vector mask generator comprises one or more M field enabled 3-to-8 decoders, one or more L field enabled 3-to-8 decoders, an n+1 bits subtractor, and n+1 XNOR gates.

20. The device of claim 18, where the finite state machine is configured to execute bit set and bit clear instructions using the vector mask generator.

21. The device of claim 15, where the device is configured to execute a double precision floating-point multiply instruction by computing a multiplication of fractions during a first clock cycle, normalizing during a second dock cycle, and rounding and post-rounding normalization during a third clock cycle.

22. The device of claim 14, where all the single instruction multiple data instructions share substantially the same data path.

23. A device comprising:
an execution unit configured to execute a plurality of instructions through substantially the same data path.

24. A method comprising:
receiving an instruction and one or more operands;
determining a plurality of program bits and one or more sets of pluralities of select input bits, based on the instruction and the one or more operands;
determining a plurality of extra adder input bits, based on the instruction and the one or more operands;
determining a plurality of multiplexer output bits, based on the plurality of program bits and the one or more sets of pluralities of select input bits;
determining one or more carry-save adder tree outputs, based on the plurality of multiplexer output bits and the plurality of extra adder input bits;
determining a carry-propagate adder sum output, based on the one or more carry-save adder tree output; and
determining the result of the instruction on the one or more operands, based on the carry-propagate adder sum output.

25. The method of claim 24, where the receiving, the determining a plurality of program bits and one or more sets of pluralities of select input bits, the determining a plurality of extra adder input bits, and determining the result of the instruction are performed in a finite state machine, where the determining a plurality of multiplexer output bits is performed in a multiplexer array, where the determining one or more carry-save adder tree outputs is performed at a carry-save adder tree, and where the determining a carry-propagate adder sum output is performed at a carry-propagate adder.

26. The method of claim 24, where the instruction comprises one of a logic, addition, subtraction, absolute value, count the number of zeros, count the number of ones, bit reverse, rotate, shift, set, clear, multiply, complex multiply accumulate, floating-point multiply, and vector sum instruction.

27. The method of claim 24, where the instruction comprises a single instruction multiple data (SIMD) instruction.

28. The method of claim 24, where the determining one or more carry-save adder tree outputs comprises adding the plurality of multiplexer output bits and the plurality of extra adder input bits.

29. The method of claim 24, further comprising:
determining a plurality of adder partitioning bits, based on the instruction, into the carry-save adder tree and into the carry-propagate adder; and
partitioning the plurality of multiplexer output bits and the plurality of extra adder input bits into distinct data units, based on the plurality of adder partitioning bits.

30. The method of claim 29, where the distinct data units comprise bytes, halves, or words.

31. The method of claim 24, where the determining a plurality of multiplexer output bits comprises assigning the program bits to input lines of multiplexers in a multiplexer array and assigning the pluralities of select input bits to select lines of the multiplexers in the multiplexer array.

32. The device of claim 1, where the finite state machine and the array of multiplexers are optimized into a logic-reduced finite state machine.

33. A computer readable medium, comprising instructions for performing the method of claim 24.

34. An integrated circuit, comprising the device of claim 1.

35. A circuit board, comprising the integrated circuit of claim 34.

36. A computer, comprising the circuit board of claim 35.

37. A computer readable medium encoding an integrated circuit according to claim 34.
